(19) United States
(12) Patent Application Publication
(10) Pub. No.: US 2026/0267486 A1
(43) Pub. Date: Sep. 10, 2026

(54) SELECTION OF OBJECTS FOR SUGGESTIONS

(71) Applicant: Apple Inc., Cupertino, CA (US)

(72) Inventors: Guilherme KLINK, Campbell, CA (US); Peter BURGNER, Venice, CA (US); Paul EWERS, San Jose, CA (US); Thomas J. MOORE, Northglenn, CO (US); Ashwin K. VIJAY, Sunnyvale, CA (US)

(21) Appl. No.: 19/535,786

(22) Filed: Feb. 10, 2026

Related U.S. Application Data
(60) Provisional application No. 63/772,250, filed on Mar. 14, 2025.
(60) Provisional application No. 63/768,634, filed on Mar. 7, 2025.

(51) Int. Cl. G06F 3/04842; G06F 3/041; G06F 3/0481; G06F 3/0482; G06T 19/20

(52) U.S. Cl. CPC G06F 3/04842; G06F 3/041; G06F 3/0481; G06F 3/0482; G06T 19/20

(57) ABSTRACT

An example method includes: at a computer system that is in communication with one or more sensor devices: detecting, via the one or more sensor devices, a first object within a three-dimensional (3D) scene; and in response to detecting, via the one or more sensor devices, the first object within the 3D scene: in accordance with a determination that a set of one or more criteria is satisfied, wherein the set of one or more criteria includes a first criterion that is satisfied when a property of the first object is within a predefined region associated with the 3D scene, providing a suggestion that is determined based on the first object; and in accordance with a determination that the set of one or more criteria is not satisfied, forgoing providing the suggestion that is determined based on the first object.

### CROSS-REFERENCE TO RELATED APPLICATIONS

This application claims priority to U.S. Patent Application No. 63/768,634, entitled “SELECTION OF OBJECTS FOR SUGGESTIONS,” filed on March 7, 2025, and to U.S. Patent Application No. 63/772,250, entitled “SELECTION OF OBJECTS FOR SUGGESTIONS,” filed on March 14, 2025, the entire contents of which are hereby incorporated by reference in their entireties.

### TECHNICAL FIELD

The present disclosure generally relates to providing suggestions for objects that are present within a three-dimensional scene.

### BACKGROUND

The development of computer systems for interacting with and/or providing three-dimensional scenes has expanded significantly in recent years. Example three-dimensional scenes (e.g., environments) include physical scenes and extended reality scenes.

### SUMMARY

Example methods are disclosed herein. An example method includes: at a computer system that is in communication with one or more sensor devices: detecting, via the one or more sensor devices, a first object within a three-dimensional (3D) scene; and in response to detecting, via the one or more sensor devices, the first object within the 3D scene: in accordance with a determination that a set of one or more criteria is satisfied, wherein the set of one or more criteria includes a first criterion that is satisfied when a property of the first object is within a predefined region associated with the 3D scene, providing a suggestion that is determined based on the first object; and in accordance with a determination that the set of one or more criteria is not satisfied, forgoing providing the suggestion that is determined based on the first object.

Example non-transitory computer-readable storage media are disclosed herein. An example non-transitory computer-readable storage medium stores one or more programs. The one or more programs are configured to be executed by one or more processors of a computer system that is in communication with one or more sensor devices. The one or more programs include instructions for: detecting, via the one or more sensor devices, a first object within a three-dimensional (3D) scene; and in response to detecting, via the one or more sensor devices, the first object within the 3D scene: in accordance with a determination that a set of one or more criteria is satisfied, wherein the set of one or more criteria includes a first criterion that is satisfied when a property of the first object is within a predefined region associated with the 3D scene, providing a suggestion that is determined based on the first object; and in accordance with a determination that the set of one or more criteria is not satisfied, forgoing providing the suggestion that is determined based on the first object.

Example computer systems are disclosed herein. An example computer system is configured to communicate with one or more sensor devices. The computer system comprises: one or more processors; and memory storing one or more programs configured to be executed by the one or more processors, the one or more programs including instructions for: detecting, via the one or more sensor devices, a first object within a three-dimensional (3D) scene; and in response to detecting, via the one or more sensor devices, the first object within the 3D scene: in accordance with a determination that a set of one or more criteria is satisfied, wherein the set of one or more criteria includes a first criterion that is satisfied when a property of the first object is within a predefined region associated with the 3D scene, providing a suggestion that is determined based on the first object; and in accordance with a determination that the set of one or more criteria is not satisfied, forgoing providing the suggestion that is determined based on the first object.

An example computer system is configured to communicate with one or more sensor devices. The computer system comprises: means for detecting, via the one or more sensor devices, a first object within a three-dimensional (3D) scene; and means, in response to detecting, via the one or more sensor devices, the first object within the 3D scene, for: in accordance with a determination that a set of one or more criteria is satisfied, wherein the set of one or more criteria includes a first criterion that is satisfied when a property of the first object is within a predefined region associated with the 3D scene, providing a suggestion that is determined based on the first object; and in accordance with a determination that the set of one or more criteria is not satisfied, forgoing providing the suggestion that is determined based on the first object.

Selectively providing a suggestion for an object based on whether a property of the object is within a predefined region may allow for more accurate, precise, and/or efficient user selection of objects for which suggestions are desired. Selectively providing a suggestion for an object based on whether a property of the object is within the predefined region may also help avoid false positive selections of undesired objects, which avoids overwhelming a user with undesired suggestions and declutters a user interface. In this manner, the user-device interface is made more accurate, efficient, and precise (e.g., by helping the user provide more accurate and precise inputs, by avoiding excessive user inputs to undo the results of unwanted actions performed by the device, and/or by helping the user to operate the device as desired), which additionally reduces power usage and improves battery life of the device by enabling the user to use the device more quickly and efficiently.

In some examples, the computer system is a desktop computer with an associated display. In some examples, the computer system is a portable device (e.g., a notebook computer, tablet computer, or handheld device such as a smartphone). In some examples, the computer system is a personal electronic device (e.g., a wearable electronic device, such as a watch or a head-mounted device). In some examples, the computer system has a touchpad. In some examples, the computer system has one or more cameras. In some examples, the computer system has a display generation component (e.g., a display device such as a head-mounted display, a display, a projector, a touch-sensitive display (also known as a “touch screen” or “touch-screen display”), or other device or component that presents visual content to a user, for example on or in the display generation component itself or produced from the display generation component and visible elsewhere). In some examples, the computer system does not have a display generation component and does not present visual content to a user. In some examples, the computer system has a touch-sensitive display (also known as a “touch screen” or “touch-screen display”). In some examples, the computer system has one or more eye-tracking components. In some examples, the computer system has one or more hand-tracking components. In some examples, the computer system has one or more output devices, the output devices including one or more tactile output generators and/or one or more audio output devices. In some examples, the computer system has one or more processors, memory, and one or more modules, programs or sets of instructions stored in the memory for performing various functions described herein. In some examples, the user interacts with the computer system through a stylus and/or finger contacts and gestures on the touch-sensitive surface, movement of the user’s eyes and hand in space or the user’s body as captured by cameras and other movement sensors, and/or voice inputs as captured by one or more audio input devices. Executable instructions for performing these functions are, optionally, included in a transitory and/or non-transitory computer-readable storage medium or other computer program product configured for execution by one or more processors.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 is a block diagram illustrating an operating environment of a computer system for interacting with three-dimensional (3D) scenes, according to some examples.

FIG. 2 is a block diagram of a user-facing component of the computer system, according to some examples.

FIG. 3 is a block diagram of a controller of the computer system, according to some examples.

FIG. 4 illustrates an architecture for a foundation model, according to some examples.

FIGS. 5A-5H, 6A-6C, and 7A-7B illustrate techniques for providing suggestions for objects that are present within 3D scenes, according to some examples.

FIG. 8 is a flow diagram of a method for providing suggestions, according to some examples.

### DETAILED DESCRIPTION

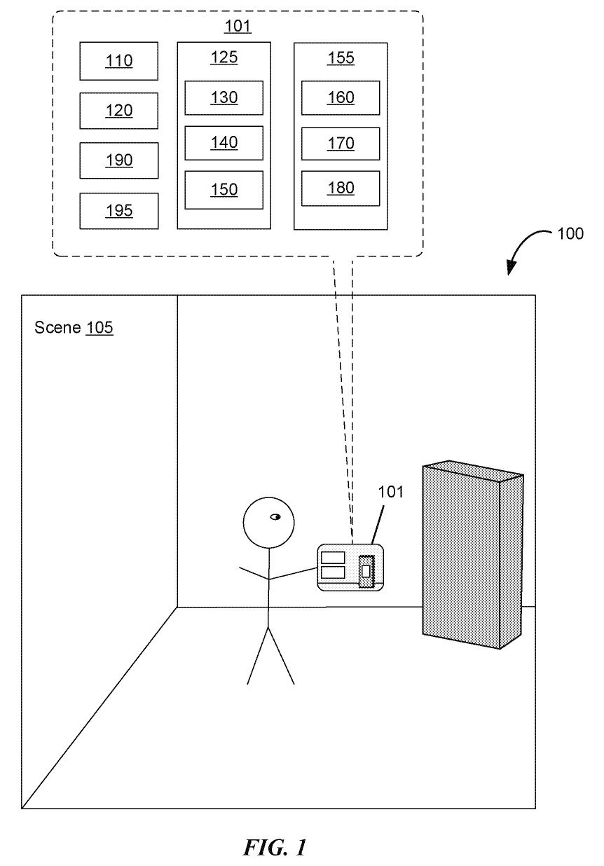

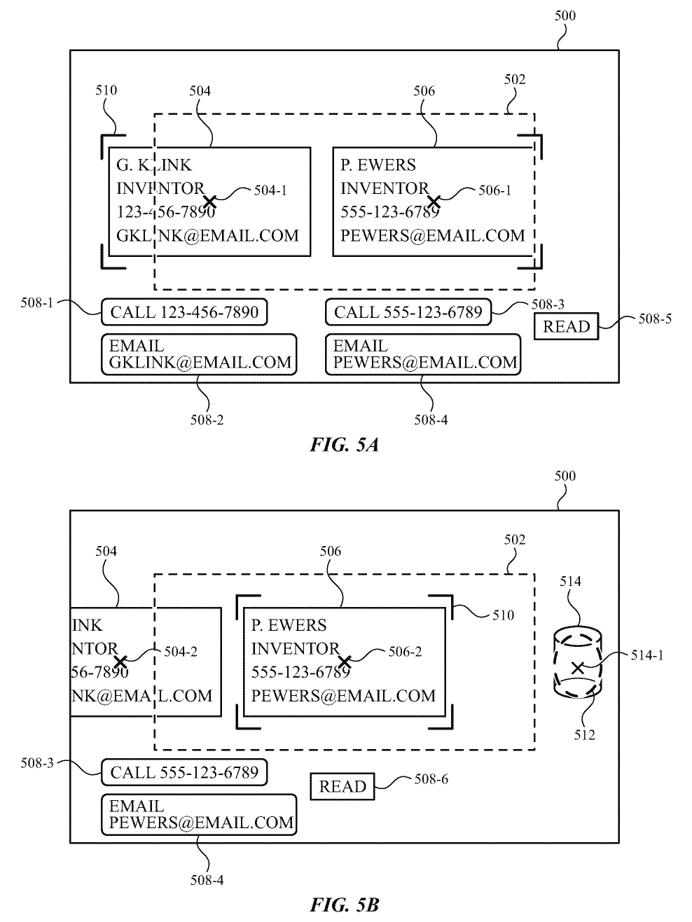

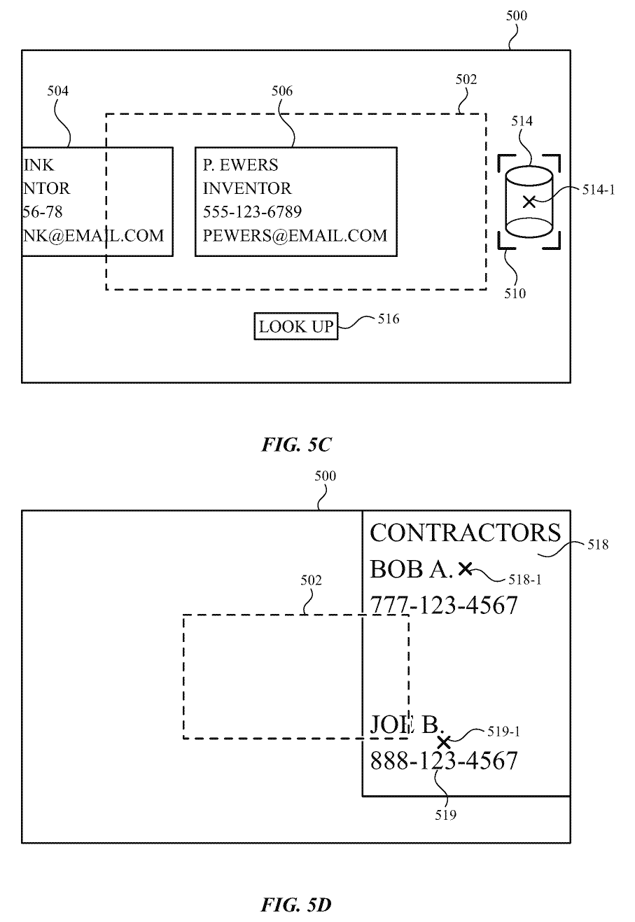

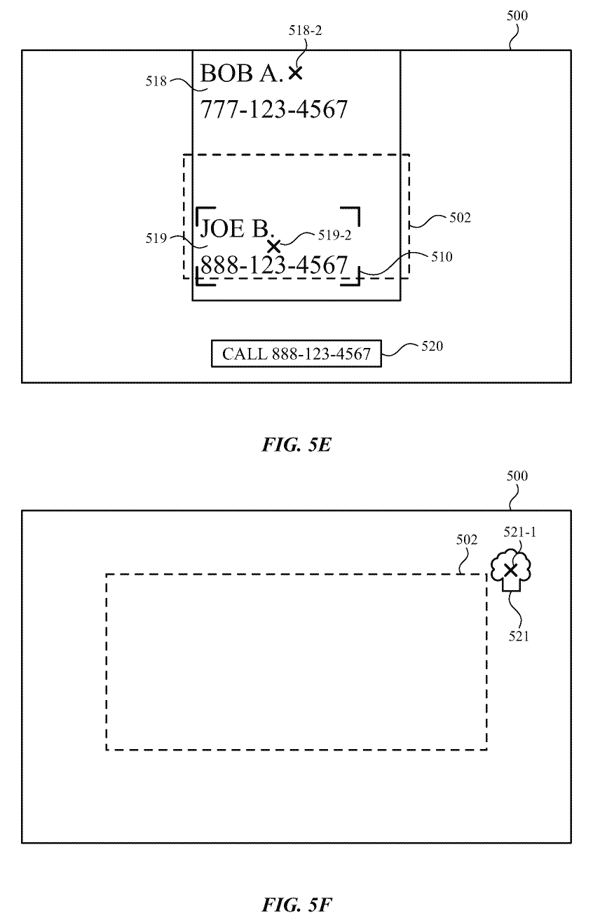

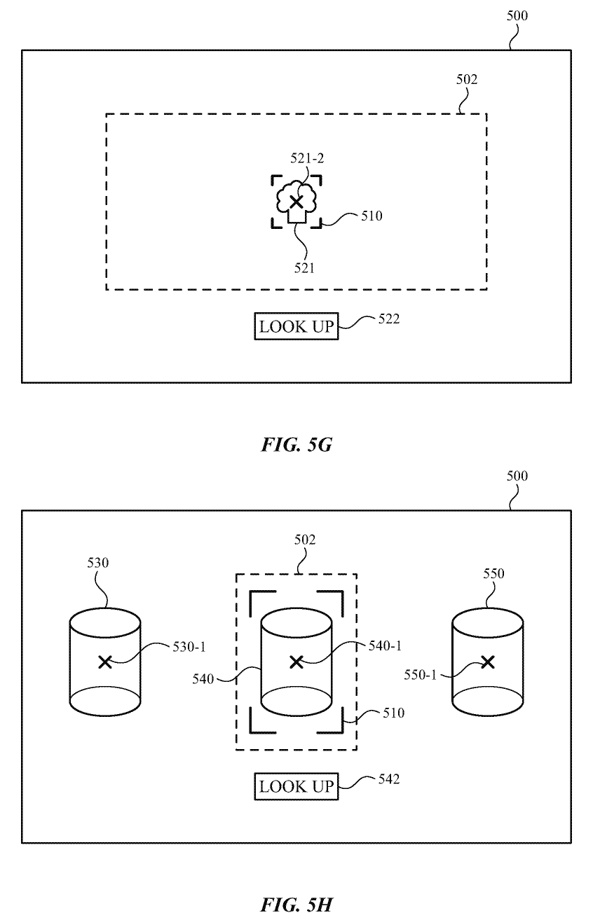

FIGS. 1-4 provide a description of example computer systems and techniques for interacting with three-dimensional scenes. FIGS. 5A-5H, 6A-6C, and 7A-7B illustrate techniques for providing suggestions for objects that are present within 3D scenes. FIG. 8 is a flow diagram of a method for providing suggestions. FIGS. 5A-5H, 6A-6C, and 7A-7B are used to describe the method of FIG. 8.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer-readable medium claims where the system or computer-readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer-readable storage medium can repeat the steps of a method as many times as are needed to ensure that all of the contingent steps have been performed.

FIG. 1 is a block diagram illustrating an operating environment of computer system 101 for interacting with three-dimensional scenes, according to some examples. In FIG. 1, a user interacts with three-dimensional scene 105 via operating environment 100 that includes computer system 101. In some examples, computer system 101 includes controller 110 (e.g., processors of a portable electronic device or a remote server), user-facing component 120, one or more input devices 125 (e.g., eye tracking device 130, hand tracking device 140, and/or other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, audio sensors, etc.), and one or more peripheral devices 195 (e.g., home appliances, wearable devices, etc.). In some examples, one or more of input devices 125, output devices 155, sensors 190, and peripheral devices 195 are integrated with user-facing component 120 (e.g., in a head-mounted device or a handheld device).

While pertinent features of the operating environment 100 are shown in FIG. 1, those of ordinary skill in the art will appreciate from the present disclosure that various other features have not been illustrated for the sake of brevity and so as not to obscure more pertinent aspects of the examples disclosed herein.

Hardware: There are many different types of electronic systems that enable a person to sense and/or interact with three-dimensional scenes. Examples include head-mounted systems, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). Alternatively, a head-mounted system may be configured to operate without displaying content, e.g., so that the head-mounted system provides output to a user via tactile and/or auditory means. The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person’s eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one example, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface.

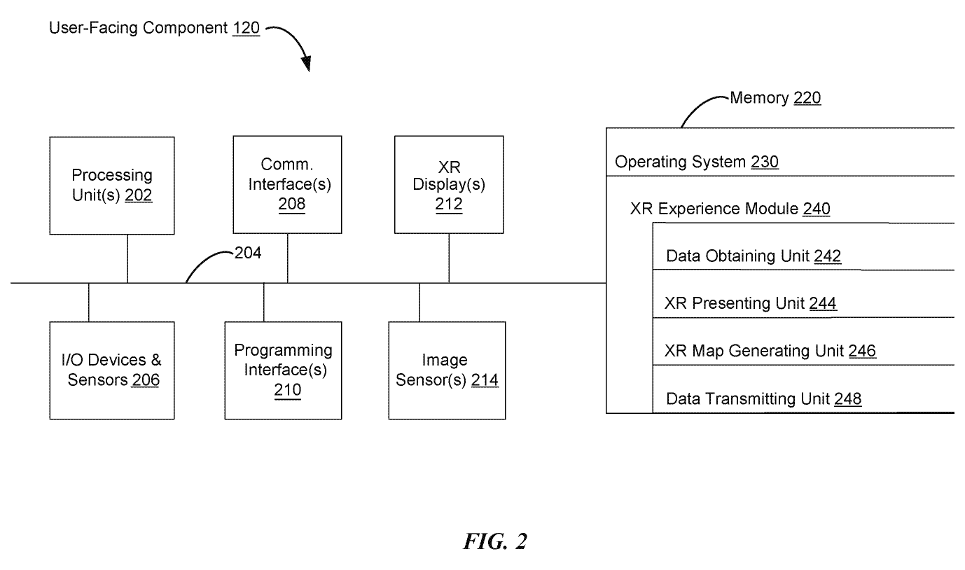

In some examples, user-facing component 120 is configured to provide a visual component of a three-dimensional scene. In some examples, user-facing component 120 includes a suitable combination of software, firmware, and/or hardware. User-facing component 120 is described in greater detail below with respect to FIG. 2. In some examples, the functionalities of controller 110 are provided by and/or combined with user-facing component 120. In some examples, user-facing component 120 provides an extended reality (XR) experience to the user while the user is virtually and/or physically present within scene 105.

In some examples, user-facing component 120 is worn on a part of the user’s body (e.g., on his/her head, on his/her hand, etc.). In some examples, user-facing component 120 includes one or more XR displays provided to display the XR content. In some examples, user-facing component 120 encloses the field-of-view of the user. In some examples, user-facing component 120 is a handheld device (such as a smartphone or tablet) configured to present XR content, and the user holds the device with a display directed towards the field-of-view of the user and a camera directed towards the scene 105. In some examples, the handheld device is optionally placed within an enclosure that is worn on the head of the user. In some examples, the handheld device is optionally placed on a support (e.g., a tripod) in front of the user. In some examples, user-facing component 120 is an XR chamber, enclosure, or room configured to present XR content in which the user does not wear or hold user-facing component 120. Many user interfaces described with reference to one type of hardware for displaying XR content (e.g., a handheld device or a device on a tripod) could be implemented on another type of hardware for displaying XR content (e.g., a head-mounted device (HMD) or other wearable computing device). For example, a user interface showing interactions with XR content triggered based on interactions that happen in a space in front of a handheld or tripod-mounted device could similarly be implemented with an HMD where the interactions happen in a space in front of the HMD and the responses of the XR content are displayed via the HMD. Similarly, a user interface showing interactions with XR content triggered based on movement of a handheld or tripod-mounted device relative to the physical environment (e.g., scene 105 or a part of the user’s body (e.g., the user’s eye(s), head, or hand)) could similarly be implemented with an HMD where the movement is caused by movement of the HMD relative to the physical environment (e.g., scene 105 or a part of the user’s body (e.g., the user’s eye(s), head, or hand)).

FIG. 2 is a block diagram of user-facing component 120, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 2 is intended more as a functional description of the various features that could be present in a particular implementation, as opposed to a structural schematic of the examples described herein. As recognized by those of ordinary skill in the art, components shown separately could be combined and some components could be separated. For example, some functional modules shown separately in FIG. 2 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, user-facing component 120 (e.g., HMD) includes one or more processing units 202 (e.g., microprocessors, ASICs, FPGAs, GPUs, CPUs, processing cores, and/or the like), one or more input/output (I/O) devices and sensors 206, one or more communication interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 210, one or more XR displays 212, one or more optional interior- and/or exterior-facing image sensors 214, a memory 220, and one or more communication buses 204 for interconnecting these and various other components.

In some examples, one or more communication buses 204 include circuitry that interconnects and controls communications between system components. In some examples, one or more I/O devices and sensors 206 include at least one of an inertial measurement unit (IMU), an accelerometer, a gyroscope, a thermometer, one or more biometric sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some examples, one or more XR displays 212 are configured to provide an XR experience to the user. In some examples, one or more XR displays 212 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some examples, one or more XR displays 212 correspond to diffractive, reflective, polarized, holographic, etc. waveguide displays. For example, user-facing component 120 (e.g., HMD) includes a single XR display. In another example, user-facing component 120 includes an XR display for each eye of the user. In some examples, one or more XR displays 212 are capable of presenting XR content. In some examples, one or more XR displays 212 are omitted from user-facing component 120. For example, user-facing component 120 does not include any component that is configured to display content (or does not include any component that is configured to display XR content) and user-facing component 120 provides output via audio and/or haptic output types.

In some examples, one or more image sensors 214 are configured to obtain image data that corresponds to at least a portion of the face of the user that includes the eyes of the user (and may be referred to as an eye-tracking camera). In some examples, one or more image sensors 214 are configured to obtain image data that corresponds to at least a portion of the user’s hand(s) and, optionally, arm(s) of the user (and may be referred to as a hand-tracking camera). In some examples, one or more image sensors 214 are configured to be forward-facing to obtain image data that corresponds to the scene as would be viewed by the user if user-facing component 120 (e.g., HMD) was not present (and may be referred to as a scene camera). One or more optional image sensors 214 can include one or more RGB cameras (e.g., with a complementary metal-oxide-semiconductor (CMOS) image sensor or a charge-coupled device (CCD) image sensor), one or more infrared (IR) cameras, one or more event-based cameras, and/or the like.

Memory 220 includes high-speed random-access memory, such as DRAM, SRAM, DDR RAM, or other random-access solid-state memory devices. In some examples, memory 220 includes non-volatile memory, such as one or more magnetic disk storage devices, optical disk storage devices, flash memory devices, or other non-volatile solid-state storage devices. Memory 220 optionally includes one or more storage devices remotely located from the one or more processing units 202. Memory 220 comprises a non-transitory computer-readable storage medium. In some examples, memory 220 or the non-transitory computer-readable storage medium of memory 220 stores the following programs, modules and data structures, or a subset thereof, including optional operating system 230 and XR experience module 240.

Operating system 230 includes instructions for handling various basic system services and for performing hardware dependent tasks. In some examples, XR experience module 240 is configured to present XR content to the user via one or more XR displays 212 or one or more speakers. To that end, in various examples, XR experience module 240 includes data obtaining unit 242, XR presenting unit 244, XR map generating unit 246, and data transmitting unit 248.

In some examples, data obtaining unit 242 is configured to obtain data (e.g., presentation data, interaction data, sensor data, location data, etc.) from at least controller 110 of FIG. 1. To that end, in various examples, data obtaining unit 242 includes instructions and/or logic therefor, and heuristics and metadata therefor.

In some examples, XR presenting unit 244 is configured to present XR content via one or more XR displays 212 or one or more speakers. To that end, in various examples, XR presenting unit 244 includes instructions and/or logic therefor, and heuristics and metadata therefor.

In some examples, XR map generating unit 246 is configured to generate an XR map (e.g., a 3D map of the extended reality scene or a map of the physical environment into which computer-generated objects can be placed) based on media content data. To that end, in various examples, XR map generating unit 246 includes instructions and/or logic therefor, and heuristics and metadata therefor.

In some examples, the data transmitting unit 248 is configured to transmit data (e.g., presentation data, location data, sensor data, etc.) to at least controller 110, and optionally one or more of input devices 125, output devices 155, sensors 190, and/or peripheral devices 195. To that end, in various examples, data transmitting unit 248 includes instructions and/or logic therefor, and heuristics and metadata therefor.

Although data obtaining unit 242, XR presenting unit 244, XR map generating unit 246, and data transmitting unit 248 are shown as residing on a single device (e.g., user-facing component 120 of FIG. 1), in other examples, any combination of data obtaining unit 242, XR presenting unit 244, XR map generating unit 246, and data transmitting unit 248 may reside on separate computing devices.

Returning to FIG. 1, controller 110 is configured to manage and coordinate a user’s experience with respect to a three-dimensional scene. In some examples, controller 110 includes a suitable combination of software, firmware, and/or hardware. Controller 110 is described in greater detail below with respect to FIG. 3.

In some examples, controller 110 is a computing device that is local or remote relative to scene 105 (e.g., a physical environment). For example, controller 110 is a local server located within scene 105. In another example, controller 110 is a remote server located outside of scene 105 (e.g., a cloud server, central server, etc.). In some examples, controller 110 is communicatively coupled with the component(s) of computer system 101 that are configured to provide output to the user (e.g., output devices 155 and/or user-facing component 120) via one or more wired or wireless communication channels (e.g., BLUETOOTH, IEEE 802.11x, IEEE 802.16x, IEEE 802.3x, etc.). In some examples, controller 110 is included within the enclosure (e.g., a physical housing) of the component(s) of computer system 101 that are configured to provide output to the user (e.g., user-facing component 120) or shares the same physical enclosure or support structure with the component(s) of computer system 101 that are configured to provide output to the user.

In some examples, the various components and functions of controller 110 described below with respect to FIGS. 3, 4, 5A-5H, 6A-6C, 7A-7B, and 8 are distributed across multiple devices. For example, a first set of the components of controller 110 (and their associated functions) are implemented on a server system remote to scene 105 while a second set of the components of controller 110 (and their associated functions) are local to scene 105. For example, the second set of components are implemented within a portable electronic device (e.g., a wearable device such as an HMD) that is present within scene 105. It will be appreciated that the particular manner in which the various components and functions of controller 110 are distributed across various devices can vary based on different implementations of the examples described herein.

FIG. 3 is a block diagram of a controller 110, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 3 is intended more as a functional description of the various features that may be present in a particular implementation, as opposed to a structural schematic of the examples described herein. As recognized by those of ordinary skill in the art, components shown separately could be combined and some components could be separated. For example, some functional modules shown separately in FIG. 3 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, controller 110 includes one or more processing units 302 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 306, one or more communication interfaces 308 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 310, memory 320, and one or more communication buses 304 for interconnecting these and various other components.

In some examples, one or more communication buses 304 include circuitry that interconnects and controls communications between system components. In some examples, one or more I/O devices 306 include at least one of a keyboard, a mouse, a touchpad, a joystick, one or more microphones, one or more speakers, one or more image sensors, one or more displays, and/or the like.

Memory 320 includes high-speed random-access memory, such as dynamic random-access memory (DRAM), static random-access memory (SRAM), double-data-rate random-access memory (DDR RAM), or other random-access solid-state memory devices. In some examples, memory 320 includes non-volatile memory, such as one or more magnetic disk storage devices, optical disk storage devices, flash memory devices, or other non-volatile solid-state storage devices. Memory 320 optionally includes one or more storage devices remotely located from the one or more processing units 302. Memory 320 comprises a non-transitory computer-readable storage medium. In some examples, memory 320 or the non-transitory computer-readable storage medium of memory 320 stores the following programs, modules and data structures, or a subset thereof, including an optional operating system 330 and three-dimensional (3D) experience module 340.

Operating system 330 includes instructions for handling various basic system services and for performing hardware-dependent tasks.

In some examples, three-dimensional (3D) experience module 340 is configured to manage and coordinate the user experience provided by computer system 101 with respect to a three-dimensional scene. For example, 3D experience module 340 is configured to obtain data corresponding to the three-dimensional scene (e.g., data generated by computer system 101 and/or data from data obtaining unit 341 discussed below) to cause computer system 101 to perform actions for the user (e.g., provide suggestions, display content, etc.) based on the data. To that end, in various examples, 3D experience module 340 includes data obtaining unit 341, tracking unit 342, coordination unit 346, data transmission unit 348, digital assistant (DA) unit 350, and suggestions unit 360.

In some examples, data obtaining unit 341 is configured to obtain data (e.g., presentation data, interaction data, sensor data, location data, etc.) from one or more of user-facing component 120, input devices 125, output devices 155, sensors 190, and peripheral devices 195. To that end, in various examples, data obtaining unit 341 includes instructions and/or logic therefor, and heuristics and metadata therefor.

In some examples, tracking unit 342 is configured to map scene 105 and to track the position/location of the user (and/or of a portable device being held or worn by the user). To that end, in various examples, tracking unit 342 includes instructions and/or logic therefor, and heuristics and metadata therefor.

In some examples, tracking unit 342 includes eye tracking unit 343. Eye tracking unit 343 includes instructions and/or logic for tracking the position and movement of the user’s gaze (or more broadly, the user’s eyes, face, or head) using data obtained from eye tracking device 130. In some examples, eye tracking unit 343 tracks the position and movement of the user’s gaze relative to a physical environment, relative to the user (e.g., the user’s hand, face, or head), relative to a device worn or held by the user, and/or relative to content displayed by user-facing component 120.

Eye tracking device 130 is controlled by eye tracking unit 343 and includes various hardware and/or software components configured to perform eye tracking techniques. For example, eye tracking device 130 includes at least one eye tracking camera (e.g., infrared (IR) or near-IR (NIR) cameras) and illumination sources (e.g., IR or NIR light sources such as an array or ring of LEDs) that emit light (e.g., IR or NIR light) towards the user’s eyes. The eye tracking cameras may be pointed towards the user’s eyes to receive reflected IR or NIR light from the light sources directly from the eyes, or alternatively may be pointed towards mirrors that reflect IR or NIR light from the eyes to the eye tracking cameras. Eye tracking device 130 optionally captures images of the user’s eyes (e.g., as a video stream captured at 60-120 frames per second), analyzes the images to generate eye tracking information, and communicates the eye tracking information to eye tracking unit 343. In some examples, two eyes of the user are separately tracked by respective eye tracking cameras and illumination sources. In some examples, only one eye of the user is tracked by a respective eye tracking camera and illumination sources.

In some examples, tracking unit 342 includes hand tracking unit 344. Hand tracking unit 344 includes instructions and/or logic for tracking, using hand tracking data obtained from hand tracking device 140, the position of one or more portions of the user’s hands and/or motions of one or more portions of the user’s hands. Hand tracking unit 344 tracks the position and/or motion relative to scene 105, relative to the user (e.g., the user’s head, face, or eyes), relative to a device worn or held by the user, relative to content displayed by user-facing component 120, and/or relative to a coordinate system defined relative to the user’s hand. In some examples, hand tracking unit 344 analyzes the hand tracking data to identify a hand gesture (e.g., a pointing gesture, a pinching gesture, a clenching gesture, and/or a grabbing gesture) and/or to identify content (e.g., physical content or virtual content) corresponding to the hand gesture, e.g., content selected by the hand gesture. In some examples, a hand gesture is an air gesture. An air gesture is a gesture that is detected without the user touching (or independently of) an input element that is part of a device (e.g., computer system 101, one or more input devices 125, hand tracking device 140, and/or device 500) and is based on detected motion of a portion (e.g., the head, one or more arms, one or more hands, one or more fingers, and/or one or more legs) of the user’s body through the air including motion of the user’s body relative to an absolute reference (e.g., an angle of the user’s arm relative to the ground or a distance of the user’s hand relative to the ground), relative to another portion of the user’s body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user’s body (e.g., a tap gesture that includes movement of a hand in a predetermined pose by a predetermined amount and/or speed, or a shake gesture that includes a predetermined speed or amount of rotation of a portion of the user’s body).

Hand tracking device 140 is controlled by hand tracking unit 344 and includes various hardware and/or software components configured to perform hand tracking and hand gesture recognition techniques. For example, hand tracking device 140 includes one or more image sensors (e.g., one or more IR cameras, 3D cameras, depth cameras, and/or color cameras, etc.) that capture three-dimensional information (e.g., a depth map) that represents a hand of a human user. The one or more image sensors capture the hand images with sufficient resolution to distinguish the fingers and their respective positions. In some examples, the one or more image sensors project a pattern of spots onto an environment that includes the hand and capture an image of the projected pattern. In some examples, the one or more image sensors capture a temporal sequence of the hand tracking data (e.g., captured three-dimensional information and/or captured images of the projected pattern) and hand tracking device 140 communicates the temporal sequence of the hand tracking data to hand tracking unit 344 for further analysis, e.g., to identify hand gestures, hand poses, and/or hand movements.

In some examples, hand tracking device 140 includes one or more hardware input devices configured to be worn and/or held by (or be otherwise attached to) one or more respective hands of the user. In such examples, hand tracking unit 344 tracks the position, pose, and/or motion of a user’s hand based on tracking the position, pose, and/or motion of the respective hardware input device. Hand tracking unit 344 tracks the position, pose, and/or motion of the respective hardware input device optically (e.g., via one or more image sensors) and/or based on data obtained from sensor(s) (e.g., accelerometer(s), magnetometer(s), gyroscope(s), inertial measurement unit(s), and the like) contained within the hardware input device. In some examples, the hardware input device includes one or more physical controls (e.g., button(s), touch-sensitive surface(s), pressure-sensitive surface(s), knob(s), joystick(s), and the like). In some examples, instead of, or in addition to, performing a particular function in response to detecting a respective type of hand gesture, computer system 101 analogously performs the particular function in response to a user input that selects a respective physical control of the hardware input device. For example, computer system 101 interprets a pinching hand gesture input as a selection of an in-focus element and/or interprets selection of a physical button of the hardware device as a selection of the in-focus element.

In some examples, coordination unit 346 is configured to manage and coordinate the experience provided to the user via user-facing component 120, one or more output devices 155, and/or one or more peripheral devices 195. To that end, in various examples, coordination unit 346 includes instructions and/or logic therefor, and heuristics and metadata therefor.

In some examples, data transmission unit 348 is configured to transmit data (e.g., presentation data, location data, etc.) to user-facing component 120, one or more input devices 125, output devices 155, sensors 190, and/or peripheral devices 195. To that end, in various examples, data transmission unit 348 includes instructions and/or logic therefor, and heuristics and metadata therefor.

Digital assistant (DA) unit 350 includes instructions and/or logic for providing DA functionality to computer system 101. DA unit 350 therefore provides a user of computer system 101 with DA functionality while they and/or their avatar are present in a three-dimensional scene. For example, the DA performs various tasks related to the three-dimensional scene, either proactively or upon request from the user. In some examples, DA unit 350 performs at least some of: converting speech input into text (e.g., using speech-to-text (STT) processing unit 352); identifying a user’s intent expressed in a natural language input received from the user; actively eliciting and obtaining information needed to fully satisfy the user’s intent (e.g., by disambiguating terms in the natural language input and/or by obtaining information from data obtaining unit 341); determining a task flow for fulfilling the identified intent; and executing the task flow to fulfill the identified intent.

In some examples, DA unit 350 includes natural language processing (NLP) unit 351 configured to identify the user intent. NLP unit 351 takes the n-best candidate text representation(s) (word sequence(s) or token sequence(s)) generated by STT processing unit 352 and attempts to associate each of the candidate text representations with one or more user intents recognized by the DA. In some examples, a user intent represents a task that can be performed by the DA and has an associated task flow implemented in task flow processing unit 353. The associated task flow is a series of programmed actions and steps that the DA takes in order to perform the task. The scope of a DA’s capabilities is, in some examples, dependent on the number and variety of task flows that are implemented in task flow processing unit 353, or in other words, on the number and variety of user intents the DA recognizes.

In some examples, once NLP unit 351 identifies a user intent based on the user request, NLP unit 351 causes task flow processing unit 353 to perform the actions required to satisfy the user request. For example, task flow processing unit 353 executes the task flow corresponding to the identified user intent to perform a task to satisfy the user request. In some examples, performing the task includes causing computer system 101 to provide output (e.g., graphical, audio, and/or haptic output) indicating the performed task.

Computer system 101 is configured to output (e.g., display and/or audibly output) indications of suggestions. Computer system 101 outputs an indication of a suggestion by providing the suggestion and/or by providing an indication that the suggestion is available. In some examples, computer system 101 receives a user input (e.g., touch input, gesture input, air gesture input, gaze input, speech input, and/or peripherical device input) that selects the indication that the suggestion is available, and in response, provides the suggestion.

Suggestions unit 360 is configured to detect objects that are present within a 3D scene and to determine suggestions based on objects that are present within a 3D scene. In some examples, suggestions unit 360 determines whether to output an indication of a suggestion.

Suggestions unit 360 implements object detection techniques to detect objects based on data (e.g., image data) from data obtaining unit 341. In some examples, suggestions unit 360 further uses object detection techniques identify/classify a detected object, e.g., as text, as a block of text, as text representing a phone number, as text representing an email address, as text in a foreign language, as text representing a physical address, as a person, as a plant, as food, as a landmark, as a body of water, or the like.

In some examples, suggestions unit 360 determines a suggestion for a detected object based on one or more rules that map the type of the detected object to one or more suggestions. As one example, if the object is text, the corresponding suggestion is to read the text aloud via a text-to-speech process. As another example, if the object is text in a foreign language, the corresponding suggestion is to translate the text into the user’s native language. As another example, if the object is a phone number, the corresponding suggestion is to call the phone number and/or to add the phone number to the user’s contact list. As another example, if the object is a plant, the corresponding suggestion is to obtain more information about the plant, e.g., obtain the identity of the plant via a web search.

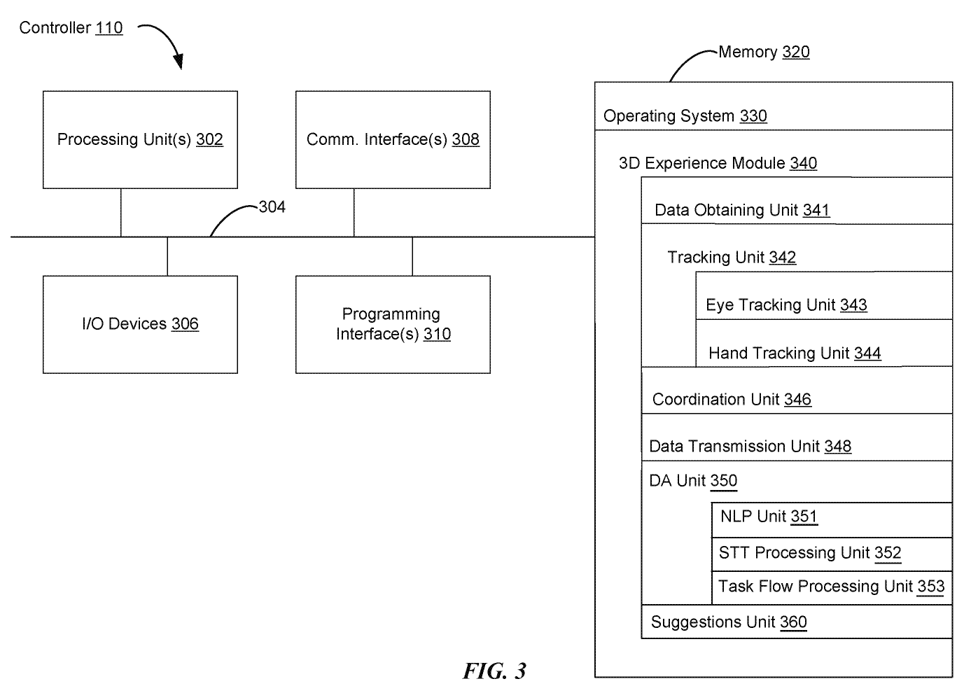

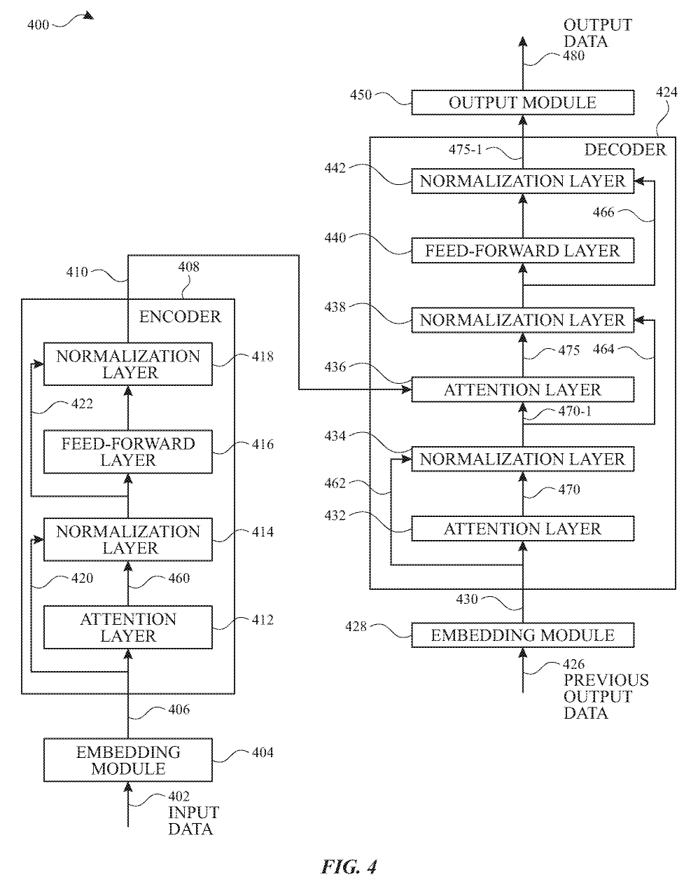

In some examples, suggestions unit 360 determines a suggestion for an object using an artificial intelligence (AI) model. The AI model is based on (e.g., is, or is constructed from) a foundation model, as discussed below with respect to FIG. 4. In some examples, suggestions unit 360 generates a prompt that requests the AI model to determine suggestions based on an input representation (e.g., an image and/or 3D model) of the object, e.g., “predict suggested actions for a user to take on [X],” where [X] denotes the input representation. Based on the input prompt, the AI model generates suggestion(s) for the object, and optionally, generates respective confidence score(s) of the suggestion(s).

In some examples, suggestions unit 360 determines whether to output an indication of a suggestion for an object based on whether a property of the object is within a region (e.g., a “selection region”) (e.g., 502, 602, or 702 in FIGS. 5A-5H, 6A-6C, and 7A-7B below) associated with the 3D scene that the object is present in. In some examples, the selection region (e.g., 502 in FIGS. 5A-5H) is a region on a display (e.g., a region having a default fixed position on the display). For example, the selection region is a top portion of a displayed user interface, a bottom portion of a displayed user interface, a central portion of the displayed user interface, a left portion of a displayed user interface, or a right portion of a displayed user interface.

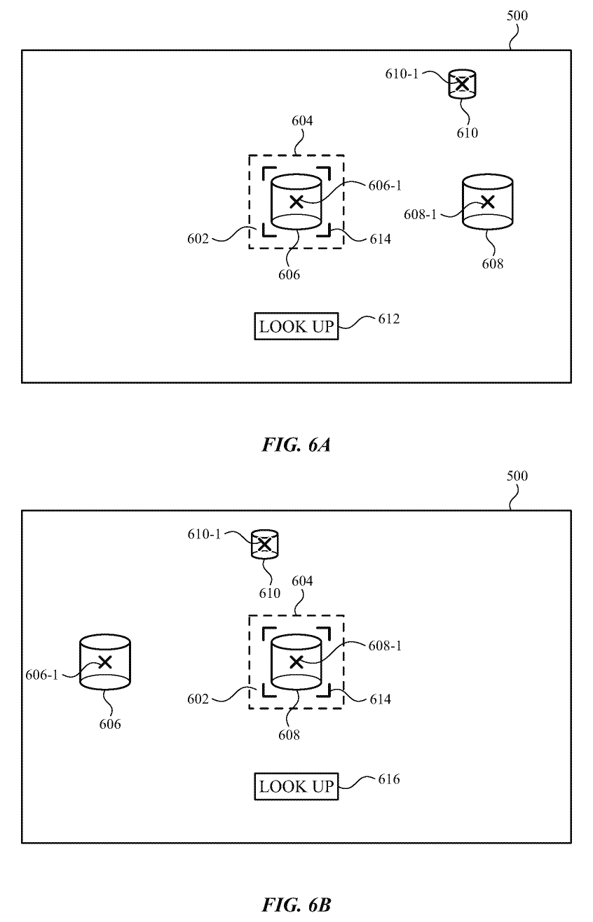

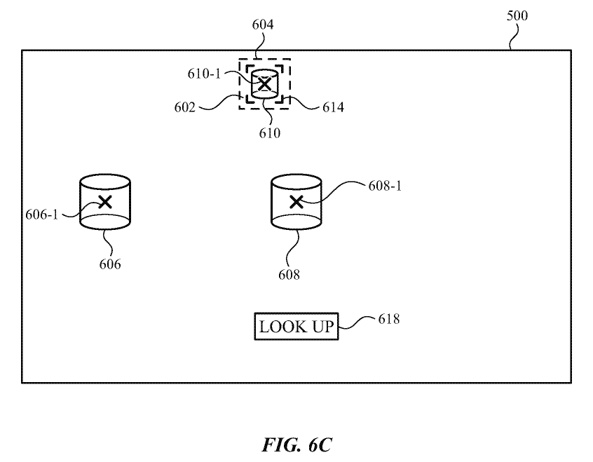

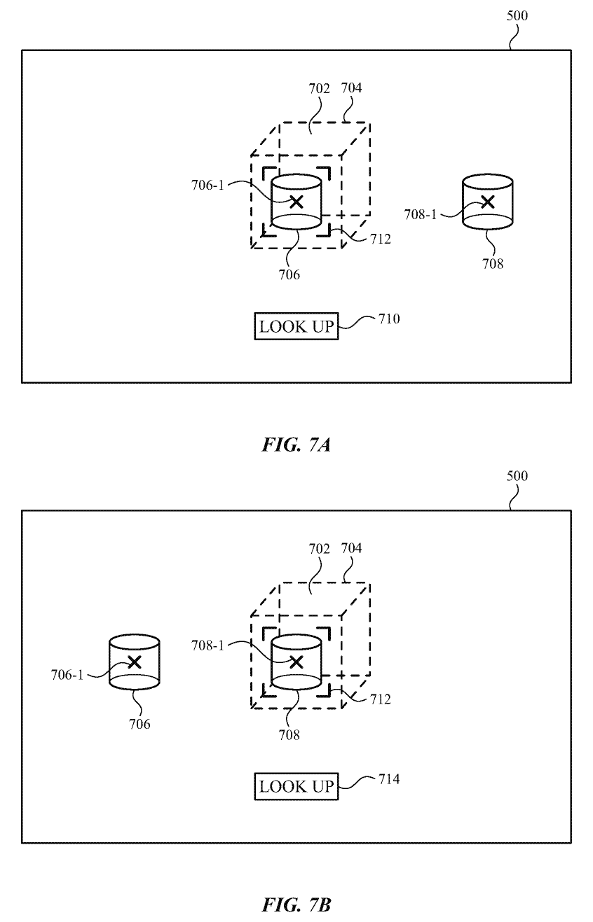

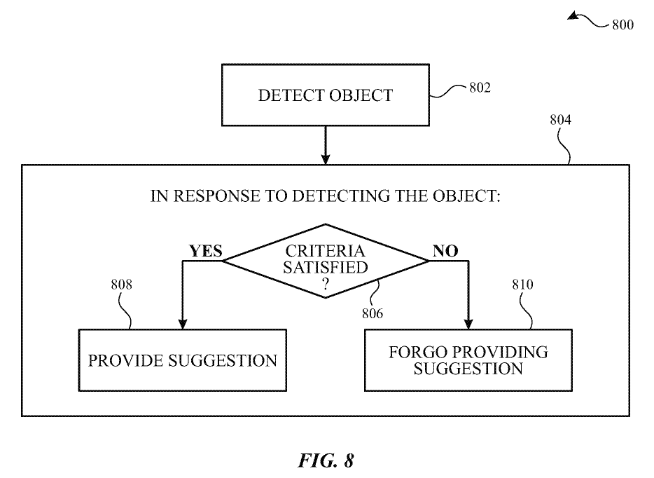

In some examples, the selection region is a 3D region (e.g., a volume) that represents a portion of a field of view (e.g., of a user and/or of one or more image sensors) of the 3D scene. In some examples, the 3D region (e.g., 602 in FIGS. 6A-6C) has substantially infinite depth (e.g., extends forward into the background of the 3D scene as far as a user can see). In some examples, the 3D region (e.g., 702 in FIGS. 7A-7B) has a finite depth. In some examples, the default position of the 3D region is based on a forward-facing direction of a user and/or the default position is a predetermined distance (e.g., 0.1 meters, 0.25 meters, 0.5 meters, or 1 meter) away from the user. For example, the default position is on a first line that extends forward from the position of a user (e.g., the user’s head or eyes) and that defines the user’s current forward-facing direction (e.g., relative to the user’s face and/or eyes). As another example, the default position is on a second line that extends forward from the position of a user and that has a predetermined amount of angular deviation (e.g., ±2°, ±5°, ±10°, or ±15°) from the first line. Accordingly, in some examples, the default position of a 3D selection region within the 3D scene changes as the user moves (e.g., changes position and/or rotates) within the 3D scene. In some examples, such as when the 3D scene is a virtual reality scene, an avatar represents the user and the default position of the 3D selection region is analogously based on a forward-facing direction of the avatar and/or is similarly a predetermined distance away from the avatar. For example, the default position is on a first line that extends forward from the position of the avatar (e.g., the avatar’s head or eyes) and that defines the avatar’s current forward-facing direction (e.g., relative to the avatar’s face and/or eyes). As another example, the default position is on a second line that extends forward from the position of the avatar and that has a predetermined amount of angular deviation (e.g., ±2°, ±5°, ±10°, or ±15°) from the first line.

In some examples, suggestions unit 360 causes computer system 101 to change a position of the selection region (e.g., 502, 602, or 702) based on user input. For example, computer system 101 receives a user input that requests to move (e.g., relative to a display and/or relative to the 3D scene) the selection region from a default position.

In some examples, the property of the object is a centroid corresponding to the object (e.g., an “effective centroid”). The effective centroid varies based on the type of the selection region (e.g., 502, 602, or 702). For example, when a display displays the object via pass-through video and the selection region (e.g., 502) is a region on the display, the effective centroid is the location on the display that is the centroid of the display of the object. Accordingly, computer system 101 can provide a suggestion for an object that has an effective centroid that is within a particular region on the display. As another example, when the selection region (e.g., 602 or 702) is a 3D region that represents a portion of a field of view of the 3D scene, the effective centroid is the location in 3D space that is determined (e.g., by an object detection process) to be the centroid of the object. Accordingly, computer system 101 can provide a suggestion for an object that has an effective centroid that is within a particular region within the 3D scene.

In some examples, the property of the object is a region corresponding to the object (e.g., an “effective region”). Like the effective centroid, the effective region varies based on the type of the selection region (e.g., 502, 602, or 702). For example, when an object is displayed and the selection region (e.g., 502) is a region on the display, the effective region of the object is the region of the display that displays the object. Accordingly, computer system 101 can provide suggestions for an object that has an effective region that is within (e.g., entirely within or partially within by at least a threshold amount, e.g., 30% within, 40% within, 50% within, or 60% within) a particular region of the display. As another example, when the selection region (e.g., 602 or 702) is a 3D region that represents a portion of a field of view of the 3D scene, the effective region is the space (e.g., area and/or volume) in the 3D scene occupied by the object. Accordingly, computer system 101 can provide suggestions for an object that has an effective region that is within (e.g., entirely within or partially within by at least a threshold amount, e.g., 30% within, 40% within, 50% within, or 60% within) a particular region of the 3D scene.

In some examples, suggestions unit 360 causes computer system 101 to adjust a dimension (e.g., length, width, height, depth, area, volume, size, and/or shape) of the selection region (e.g., 502, 602, or 702). For example, computer system 101 adjusts the dimension of the selection region in response to receiving a user input that corresponds to an explicit request to adjust the dimension of the selection region.

In some examples, suggestions unit 360 causes computer system 101 to automatically adjust a dimension (e.g., length, width, height, depth, area, volume, size, and/or shape) of the selection region (e.g., 502, 602, or 702) based on a size of an object. In some examples, when the object is text, the size of the object is the font size of the text. In some examples, the size of the object and the size (e.g., area or volume) of the selection region have an inverse relationship, so that as the size of the object decreases, computer system 101 increases the size of the selection region (and vice-versa). In some examples, the selection region has a default size, and computer system 101 increases the size of the selection region if the size of the object is smaller than a threshold size, and/or computer system 101 decreases the size of the selection region if the size of the object is larger than a threshold size. Having an inverse relationship between the size of an object and the size of the selection region may advantageously allow the user to more precisely select a large object for suggested actions (e.g., among multiple large objects) while allowing the user to more easily select a small object for suggested actions.

In some examples, the size of the object and the size (e.g., area or volume) of the selection region have a direct relationship, so that as the size of the object increases, computer system 101 increases the size of the selection region and as the size of the object decreases, computer system 101 decreases the size of the selection region. In some examples, the selection region has a default size, and computer system 101 increases the size of the selection region if the size of the object is larger than a threshold size, and/or computer system 101 decreases the size of the selection region if the size of the object is smaller than a threshold size. Having a direct relationship between the size of an object and the size of the selection region may advantageously allow the user to more precisely select among smaller objects (e.g., objects that appear small to a user) for suggested actions while allowing the user to more easily select a larger object for suggested actions.

In some examples, the size of an object is the actual size of the object, meaning the size of the object as measured in feet, meters, square feet, square meters, cubic feet, cubic meters, or another unit of measurement. In some examples, the size of an object is the perceived size of the object. In some examples, the perceived size of an object is defined by the amount (e.g., percentage) of a field of view that the object occupies. In some examples, suggestions unit 360 adjusts the size (e.g., perceived size and/or actual size) of the selection region based on the actual size of an object. In some examples, suggestions unit 360 adjusts the size (e.g., perceived size and/or actual size) of the selection region based on the perceived size of an object.

In some examples, suggestions unit 360 causes computer system 101 to automatically adjust a dimension (e.g., length, width, height, depth, area, volume, size, and/or shape) of the selection region (e.g., 502, 602, or 702) based on a distance between computer system 101 (or the user of computer system 101, or an avatar of the user) and an object. For example, the distance and the size of the selection region have a direct relationship, so that as the distance decreases, computer system 101 decreases the size of the selection region, and as the distance increases, computer system 101 increases the size of the selection region. In some examples, the selection region has a default size, and computer system 101 increases the size of the selection region if the distance is larger than a threshold distance (e.g., 3 meters, 5 meters, or 10 meters), and/or computer system 101 decreases the size of the selection region if the distance is smaller than a threshold distance (e.g., 1 meter, 0.5 meters). Having a direct relationship between the distance and the size of the selection region may advantageously allow the user to more precisely select among closer objects for suggested actions while allowing the user to more easily select farther objects for suggested actions.

In some examples, the distance between computer system 101 (or the user of computer system 101, or an avatar of the user) and an object and the size of the selection region have an inverse relationship, so that as the distance decreases, computer system 101 increases the size of the selection region, and as the distance increases, computer system 101 decreases the size of the selection region. In some examples, the selection region has a default size, and computer system 101 increases the size of the selection region if the distance is smaller than a threshold distance (e.g., 3 meters, 5 meters, or 10 meters), and/or computer system 101 decreases the size of the selection region if the distance is larger than a threshold distance (e.g., 1 meter, 0.5 meters). Having an inverse relationship between the distance and the size of the selection region may advantageously allow the user to more precisely select among farther objects (e.g., that appear small to a user) for suggested actions while allowing the user to more easily select closer objects (e.g., that appear larger to a user) for suggested actions.

In some examples, suggestions unit 360 determines whether to output an indication of a suggestion for an object based on a confidence score of the suggestion, e.g., based on whether the confidence score exceeds a threshold score. In some examples, the confidence score of the suggestion is determined by the AI model that is used to determine the suggestion. In some examples, the confidence score of the suggestion is an object identification confidence score (e.g., indicating a confidence that the object is correctly identified) determined by the object detection process that operates on the corresponding object.

In some examples, suggestions unit 360 determines whether to output an indication of a suggestion for an object based on a size of the object. For example, if the size of the object (e.g., actual size or perceived size) is less than a threshold size, suggestions unit 360 causes computer system 101 to forgo outputting any indications of suggestions for the object. As another example, suggestions unit 360 decreases the confidence score of a suggestion for an object if the size of the object is less than a threshold size and/or decreases the confidence score by an amount that is inversely related to the size of the object.

Suggestions unit 360 considers one or more of the above-described conditions (e.g., whether a property of the object is within the selection region, the confidence score, and/or the size of the object) to determine whether to output an indication of a suggestion for an object. In some examples, computer system 101 outputs an indication of a suggestion if any one or more of the above-described conditions for outputting the indication of the suggestion are satisfied. In some examples, computer system 101 forgoes outputting an indication of a suggestion if any one or more of the above-described conditions for outputting the indication of the suggestion are not satisfied.

In some examples, suggestions unit 360 causes computer system 101 to output an indication of a suggestion for an object within a 3D scene in response to user input that selects the object, e.g., regardless of whether one or more of the above-described conditions are satisfied. Accordingly, in some examples, computer system 101 receives a user input (e.g., speech input, touch input, gesture input, gaze input, air gesture input, and/or peripheral device input) that selects an object that has a property (e.g., an effective region and/or an effective centroid) that is not within the selection region (e.g., 502, 602, or 702). However, in response to the user input, computer system 101 still outputs an indication of a suggestion that is determined based on the selected object.

In some examples, suggestions unit 360 causes computer system 101 to display a reticle around the object(s) for which respective suggestion(s) are indicated. For example, in response to receiving user input that selects an object, computer system 101 displays a reticle (e.g., 510, 614, or 712) around the object. In some examples, suggestions unit 360 causes computer system 101 to display a single reticle around multiple objects, for each of which a suggestion is indicated. A dimension (e.g., length, width, height, size, area, and/or volume) of the single reticle is based on the respective dimensions (e.g., lengths, widths, heights, sizes, areas, and/or volumes) of the multiple objects. For example, a first dimension of the single reticle is based on a difference between a first coordinate that represents the maximum height of the multiple objects and a second coordinate that represents the minimum height of the multiple objects. Similarly, a second dimension of the single reticle is based on a difference between a first coordinate that represents the rightmost coordinate of the multiple objects and a second coordinate that represents the leftmost coordinate of the multiple objects. In this manner, the single reticle can surround the objects for which suggestions are indicated, thereby providing the user with improved feedback about the objects for which suggestions are relevant.

In some examples, if no suggestions (that are determined based on object(s) in a 3D scene) are indicated, computer system 101 does not display any reticle, even if computer system 101 detects one or more objects within the 3D scene. In other examples, computer system 101 displays a reticle to represent detected object(s), even if suggestion(s) are not indicated for the detected object(s).

In some examples, 3D experience module 340 accesses one or more artificial intelligence (AI) models that are configured to perform various functions described herein. The AI model(s) are at least partially implemented on controller 110 (e.g., implemented locally on a single device, or implemented in a distributed manner) and/or controller 110 communicates with one or more external services that provide access to the AI model(s). In some examples, one or more components and functions of DA unit 350 and/or suggestions unit 360 are implemented using the AI model(s). For example, DA unit 350 implements one or more AI models to perform speech recognition, intent determination (e.g., natural language processing and/or image processing), object recognition, and/or response generation and suggestions unit 360 implements one or more AI models to generate suggestions and/or to detect objects.

In some examples, the AI model(s) are based on (e.g., are, or are constructed from) one or more foundation models. Generally, a foundation model is a deep learning neural network that is trained based on a large training dataset and that can adapt to perform a specific function. Accordingly, a foundation model aggregates information learned from a large (and optionally, multimodal) dataset and can adapt to (e.g., be fine-tuned to) perform various downstream tasks that the foundation model may not have been originally designed to perform. Examples of such tasks include language translation, speech recognition, user intent determination (e.g., natural language processing), sentiment analysis, computer vision tasks (e.g., object recognition and scene understanding), question answering, image generation, audio generation, and generation of computer-executable instructions. Foundation models can accept a single type of input (e.g., text data) or accept multimodal input, such as two or more of text data, image data, video data, audio data, sensor data, and the like. In some examples, a foundation model is prompted to perform a particular task by providing it with a natural language description of the task. Example foundation models include the GPT-n series of models (e.g., GPT-1, GPT-2, GPT-3, and GPT-4), DALL-E, and CLIP from Open AI, Inc., Florence and Florence-2 from Microsoft Corporation, BERT from Google LLC, and LLaMA, LLaMA-2, and LLaMA-3 from Meta Platforms, Inc.

FIG. 4 illustrates architecture 400 for a foundation model, according to some examples. Architecture 400 is merely exemplary and various modifications to architecture 400 are possible. Accordingly, the components of architecture 400 (and their associated functions) can be combined, the order of the components (and their associated functions) can be changed, components of architecture 400 can be removed, and other components can be added to architecture 400. Further, while architecture 400 is transformer-based, one of skill in the art will understand that architecture 400 can additionally or alternatively implement other types of machine learning models, such as convolutional neural network (CNN)-based models and recurrent neural network (RNN)-based models.

Architecture 400 is configured to process input data 402 to generate output data 480 that corresponds to a desired task. Input data 402 includes one or more types of data, e.g., text data, image data, video data, audio data, sensor (e.g., motion sensor, biometric sensor, temperature sensor, and the like) data, computer-executable instructions, structured data (e.g., in the form of an XML file, a JSON file, or another file type), and the like. In some examples, input data 402 includes data from data obtaining unit 341. Output data 480 includes one or more types of data that depend on the task to be performed. For example, output data 480 includes one or more of: text data, image data, audio data, and computer-executable instructions. It will be appreciated that the above-described input and output data types are merely exemplary and that architecture 400 can be configured to accept various types of data as input and generate various types of data as output. Such data types can vary based on the particular function the foundation model is configured to perform.

Architecture 400 includes embedding module 404, encoder 408, embedding module 428, decoder 424, and output module 450, the functions of which are now discussed below.

Embedding module 404 is configured to accept input data 402 and parse input data 402 into one or more token sequences. Embedding module 404 is further configured to determine an embedding (e.g., a vector representation) of each token that represents each token in embedding space, e.g., so that similar tokens have a closer distance in embedding space and dissimilar tokens have a further distance. In some examples, embedding module 404 includes a positional encoder configured to encode positional information into the embeddings. The respective positional information for an embedding indicates the embedding’s relative position in the sequence. Embedding module 404 is configured to output embedding data 406 of the input data by aggregating the embeddings for the tokens of input data 402.

Encoder 408 is configured to map embedding data 406 into encoder representation 410. Encoder representation 410 represents contextual information for each token that indicates learned information about how each token relates to (e.g., attends to) each other token. Encoder 408 includes attention layer 412, feed-forward layer 416, normalization layers 414 and 418, and residual connections 420 and 422. In some examples, attention layer 412 applies a self-attention mechanism on embedding data 406 to calculate an attention representation (e.g., in the form of a matrix) of the relationship of each token to each other token in the sequence. In some examples, attention layer 412 is multi-headed to calculate multiple different attention representations of the relationship of each token to each other token, where each different representation indicates a different learned property of the token sequence. Attention layer 412 is configured to aggregate the attention representations to output attention data 460 indicating the cross-relationships between the tokens from input data 402. In some examples, attention layer 412 further masks attention data 460 to suppress data representing the relationships between select tokens. Encoder 408 then passes (optionally masked) attention data 460 through normalization layer 414, feed-forward layer 416, and normalization layer 418 to generate encoder representation 410. Residual connections 420 and 422 can help stabilize and shorten the training and/or inference process by respectively allowing the output of embedding module 404 (i.e., embedding data 406) to directly pass to normalization layer 414 and allowing the output of normalization layer 414 to directly pass to normalization layer 418.

While FIG. 4 illustrates that architecture 400 includes a single encoder 408, in other examples, architecture 400 includes multiple stacked encoders configured to output encoder representation 410. Each of the stacked encoders can generate different attention data, which may allow architecture 400 to learn different types of cross-relationships between the tokens and generate output data 410 based on a more complete set of learned relationships.

Decoder 424 is configured to accept encoder representation 410 and previous output embedding 430 as input to generate output data 480. Embedding module 428 is configured to generate previous output embedding 430. Embedding module 428 is similar to embedding module 404. Specifically, embedding module 428 tokenizes previous output data 426 (e.g., output data 480 that was generated by the previous iteration), determines embeddings for each token, and optionally encodes positional information into each embedding to generate previous output embedding 430.

Decoder 424 includes attention layers 432 and 436, normalization layers 434, 438, and 442, feed-forward layer 440, and residual connections 462, 464, and 466. Attention layer 432 is configured to output attention data 470 indicating the cross-relationships between the tokens from previous output data 426. Attention layer 432 is similar to attention layer 412. For example, attention layer 432 applies a multi-headed self-attention mechanism on previous output embedding 430 and optionally masks attention data 470 to suppress data representing the relationships between select tokens (e.g., the relationship(s) between a token and future token(s)) so architecture 400 does not consider future tokens as context when generating output data 480. Decoder 424 then passes (optionally masked) attention data 470 through normalization layer 434 to generate normalized attention data 470-1.

Attention layer 436 accepts encoder representation 410 and normalized attention data 470-1 as input to generate encoder-decoder attention data 475. Encoder-decoder attention data 475 correlates input data 402 to previous output data 426 by representing the relationship between the output of encoder 408 and the previous output of decoder 424. Attention layer 436 allows decoder 424 to increase the weight of the portions of encoder representation 410 that are learned as more relevant to generating output data 480. In some examples, attention layer 436 applies a multi-headed attention mechanism to encoder representation 410 and to normalized attention data 470-1 to generate encoder-decoder attention data 475. In some examples, attention layer 436 further masks encoder-decoder attention data 475 to suppress the cross-relationships between select tokens.

Decoder 424 then passes (optionally masked) encoder-decoder attention data 475 through normalization layer 438, feed-forward layer 440, and normalization layer 442 to generate further-processed encoder-decoder attention data 475-1. Normalization layer 442 then provides further-processed encoder-decoder attention data 475-1 to output module 450. Similar to residual connections 420 and 422, residual connections 462, 464, and 466 may stabilize and shorten the training and/or inference process by allowing the output of a corresponding component to directly pass as input to a corresponding component.

While FIG. 4 illustrates that architecture 400 includes a single decoder 424, in other examples, architecture 400 includes multiple stacked decoders each configured to learn/generate different types of encoder-decoder attention data 475. This allows architecture 400 to learn different types of cross-relationships between the tokens from input data 402 and the tokens from output data 480, which may allow architecture 400 to generate output data 480 based on a more complete set of learned relationships.

Output module 450 is configured to generate output data 480 from further-processed encoder-decoder attention data 475-1. For example, output module 450 includes one or more linear layers that apply a learned linear transformation to further-processed encoder-decoder attention data 475-1 and a softmax layer that generates a probability distribution over the possible classes (e.g., words or symbols) of the output tokens based on the linear transformation data. Output module 450 then selects (e.g., predicts) an element of output data 480 based on the probability distribution. Architecture 400 then passes output data 480 as previous input data 426 to embedding module 428 to begin another iteration of the training and/or inference process for architecture 400.

It will be appreciated that various different AI models can be constructed based on the components of architecture 400. For example, some large language models (LLMs) (e.g., GPT-2 and GPT-3) are decoder-only (e.g., include one or more instances of decoder 424 and do not include encoder 408), some LLMs (e.g., BERT) are encoder-only (include one or more instances of encoder 408 and do not include decoder 424), and other foundation models (e.g., Florence-2) are encoder-decoder (e.g., include one or more instances of encoder 408 and include one or more instances of decoder 424). Further, it will be appreciated that the foundation models constructed based on the components of architecture 400 can be fine-tuned based on reinforcement learning techniques and training data specific to a particular task for optimization for the particular task, e.g., extracting relevant semantic information from image and/or video data, generating code, generating music, providing suggestions relevant to a specific user, and the like.

FIGS. 5A-5H, 6A-6C, and 7A-7B illustrate techniques for providing suggestions for objects that are present within 3D scenes, according to some examples.

FIGS. 5A-5H, 6A-6C, and 7A-7B illustrate a user’s view of respective 3D scenes. In some examples, device 500 provides at least a portion of the scenes of FIGS. 5A-5H, 6A-6C, and 7A-7B. For example, the scenes are XR scenes that include at least some virtual elements generated by device 500. In other examples, the scenes are physical scenes.

Device 500 implements at least some of the components of computer system 101. In some examples, device 500 is an HMD (e.g., an XR headset or a pair of glasses) and FIGS. 5A-5H, 6A-6C, and 7A-7B illustrate the user’s view of the respective scenes via the HMD. In some examples, FIGS. 5A-5H, 6A-6C, and 7A-7B illustrate physical scenes viewed via pass-through video, physical scenes viewed via direct optical see-through, physical scenes directly viewed by the user (e.g., without viewing the physical scene via device 500), or virtual scenes viewed via one or more optional displays of device 500. In some examples, device 500 is another type of device, such as a smart watch, a smart phone, a tablet device, a laptop computer, a projection-based device, headphones, or a set of earbuds.

The examples of FIGS. 5A-5H, 6A-6C, and 7A-7B illustrate that the user and device 500 are present within the respective scenes. For example, the scenes are physical or extended reality scenes and the user and device 500 are physically present within the scenes. In other examples, an avatar of the user is present within the scenes. For example, when the scenes are virtual reality scenes, the avatar of the user is present within the virtual reality scenes.

While the examples of FIGS. 5A-5H, 6A-6C, and 7A-7B illustrate that device 500 displays suggestions via a display, in some examples, device 500 does not have a display and device 500 provides suggestions in another manner. For example, when device 500 does not have a display, device 500 audibly outputs the suggestions and/or transmits the suggestions to a display capable device and the display capable device displays the suggestions.

In FIGS. 5A-5H, selection region 502 is a central area on the display of device 500 and the dashed lines indicate selection region 502. In some examples, device 500 does not display a representation of selection region 502 (e.g., the dashed lines) and the dashed lines in FIGS. 5A-5H are for illustrative purposes only. In other examples, device 500 displays a representation of selection region 502, e.g., by displaying the dashed lines.

In FIG. 5A, device 500 detects business card 504 and business card 506 (e.g., as separate blocks of text). Device 500 determines that the respective properties of business cards 504 and 506 (e.g., centroids 504-1 and 506-1 of the display of business cards 504 and 506 on the display) are each within selection region 502. Accordingly, device 500 displays suggestions 508-1 (to call a phone number on business card 504), 508-2 (to draft an email to the email address on business card 504), 508-3 (to call a phone number on business card 506), 508-4 (to draft an email to the email address on business card 506), and 508-5 (to read the text on business cards 504 and 506 via a text-to-speech process) that are determined based on business cards 504 and 506. In some examples, device 500 receives a user input that selects one or more of suggestions 508-1 – 508-5, and in response, device 500 initiates (e.g., using a respective application such as a phone application and/or an email application) the corresponding one or more actions. In FIG. 5A, device 500 further displays reticle 510 around business cards 504 and 506 to indicate that suggestions 508-1 – 508-5 are for business cards 504 and 506.

In FIG. 5B, the user’s view of the 3D scene changes relative to FIG. 5A, e.g., due to movement of the user and/or movement of device 500. Due to the change in view, device 500 determines that the respective property of business card 504 (e.g., centroid 504-2 of the display of business card 504 on the display) is no longer within selection region 502. Device 500 thus ceases to display suggestions 508-1 and 508-2 for business card 504. In FIG. 5B, device 500 determines that the respective property of business card 506 (e.g., centroid 506-2 of the display of business card 506 on the display) remains within selection region 502. Device 500 thus continues to display suggestions 508-3 and 508-4 determined based on business card 506 and device 500 displays new suggestion 508-6 (to read the text on business card 506 via a text-to-speech process). Device 500 further ceases to display reticle 510 around business cards 504 and 506 and instead displays reticle 510 around business card 506 to indicate that suggestions 508-3, 508-4, and 508-6 are for business card 506, not business card 504.

In FIG. 5B, device 500 receives touch input 512 that selects object 514. Notably, a property (e.g., centroid 514-1 of the display of object 514 on the display and/or the region of the display that displays object 514) is not within selection region 502 when touch input 512 is received. In FIG. 5C, in response to receiving touch input 512, device 500 displays suggestion 516 (to perform a web search using an image of object 514) that is determined based on object 514 and ceases to display suggestions 508-3, 508-4, and 508-6 for business card 506. In response to receiving touch input 512, device 500 further displays reticle 510 around object 514 (and ceases to display reticle 510 around business card 506) to indicate that suggestion 516 is for object 514. In other examples, device 500 receives another type of input that selects object 514, e.g., speech input, gaze input, gesture input, air gesture input, and/or input via a peripheral device, and in response to the other type of input, device 500 performs the same actions as described with respect to FIGS. 5B-5C.

In FIG. 5D, device 500 detects text blocks 518 and 519 and determines to adjust the size of selection region 502 based on the size (e.g., font size) of text blocks 518 and 519. Specifically, because the font size of text blocks 518 and 519 is relatively large (e.g., compared to the font size of the text in business cards 504 and 506 in FIGS. 5A-5C), device 500 reduces the size of selection region 502. In contrast, in FIGS. 5A-5C, because the font size of the text in business cards 504 and 506 is relatively small, device 500 sets the size of selection region 502 to be larger than the size of selection region 502 in FIG. 5D.

In FIG. 5D, device 500 determines that neither of the respective properties of text blocks 518 and 519 (e.g., centroids 518-1 and 519-1 of the display of text blocks 518 and 519 on the display) is within selection region 502. Device 500 thus does not display any suggestions for text blocks 518 and 519 and does not display reticle 510.

In FIG. 5E, the user’s view of the 3D scene changes relative to FIG. 5D, e.g., due to movement of the user and/or movement of device 500. Due to the change in view, device 500 determines that the respective property of text block 519 (e.g., centroid 519-2 of the display of text block 519 on the display) is now within selection region 502 and that the respective property of text block 518 (e.g., centroid 518-2 of the display of text block 518 on the display) remains outside of selection region 502. Device 500 thus displays suggestion 520 (to call a phone number in text block 519) without displaying any suggestions for text block 518. Device 500 further displays reticle 510 to indicate that suggestion 520 is for text block 519.

FIGS. 5A and 5E illustrate that changing the size of selection region 502 (e.g., the area of selection region 502 on the display) based on the size (e.g., font size) of a detected object (e.g., text) may allow for more precise user selection of a desired object for suggestions while still allowing the user to adequately select an appropriate amount of content for suggestions. For example, in FIG. 5E, the smaller size of suggestions selection 502 allows the user to more precisely select the contractor Joe B. (instead of the contractor Bob A.), thereby avoiding overwhelming the user with potentially undesired suggestions and/or cluttering the user interface with potentially undesired suggestions. And in FIG. 5A, the larger size of selection region 502 allows the user to more easily select more content for suggestions, without requiring excessive user input.

In other examples, as discussed above with respect to suggestions unit 360, device 500 increases the size of suggestions region 502 if detected object(s) are larger and device 500 decreases the size of suggestions region 502 if detected object(s) are smaller. Specifically, in an alternative example, the size of selection region 502 in FIGS. 5A-5C is smaller than the size of selection region 502 in FIGS. 5D-5E, thereby allowing the user to more precisely select among smaller objects (e.g., blocks of text with small font sizes) for suggestions and to more easily select larger objects (e.g., text blocks 518 and/or 519) for suggestions.

In FIG. 5F, device 500 detects object 521 within the 3D scene. Device 500 further determines that object 521 is relatively far away from device 500 and/or the user, e.g., as compared to the distance between objects 530, 540, and 550 and device 500 in FIG. 5H. Because object 521 is relatively far away, device 500 sets the size of selection region 502 in FIG. 5F to be relatively large (e.g., as compared to the size of selection region 502 in FIG. 5H).

In FIG. 5F, device 500 determines that a property of object 521 (e.g., centroid 521-1 of the display of object 521 on the display and/or the region of the display that displays object 521) is not within selection region 502. Device 500 thus does not provide any suggestions for object 521 and does not display reticle 510.

FIG. 5G, the user’s view of the 3D scene changes relative to FIG. 5F (e.g., due to movement of the user and/or movement of device 500) but the distance between device 500 and object 521 remains substantially the same in FIGS. 5F-5G. Thus, the size of selection region 502 remains substantially the same in FIGS. 5F-5G. In FIG. 5G, due to the change in view between FIGS. 5F-5G, device 500 determines that the property of object 521 (e.g., centroid 521-2 of the display of object 521 on the display and/or the region of the display that displays object 521) is now within selection region 502. Device 500 thus displays suggestion 522 (to perform a web search using an image of object 521) that is determined based on object 521 and device 500 and displays reticle 510 around object 521 to indicate that suggestion 522 is for object 521.

In FIG. 5H, device 500 detects objects 530, 540, and 550. Device 500 further determines that objects 530, 540, and 550 are relatively close to device 500 and/or the user (e.g., as compared to the distance between object 521 and device 500 and/or the user). Because objects 530, 540, and 550 are relatively close, device 500 decreases the size of selection region 502 in FIG. 5H (e.g., as compared to the size of selection region 502 in FIGS. 5F-5G).

In FIG. 5H, device 500 determines that a property of object 540 (e.g., centroid 540-1 of the display of object 540 on the display and/or the region of the display that displays object 540) is within selection region 502 and that the respective properties of objects 530 and 550 (e.g., centroids 530-1 and 550-1 of the displays of objects 530 and 550 on the display and/or the regions on the display that display objects 530 and 550) are not within selection region 502. Device 500 thus displays suggestion 542 (to perform a web search using an image of object 540) that is determined based on object 540 and does not display any suggestions for objects 530 and 550. Device 500 further displays reticle 510 around object 540 to indicate that suggestion 542 is for object 540, not for objects 530 or 550.

FIGS. 5F-5H illustrate that changing the size of selection region 502 (e.g., the area occupied by selection region 502 on the display) based on a distance between an object (e.g., 521, 530, 540, and/or 550) and device 500 (and/or the user) allows a user to more easily select farther objects and to more precisely select among closer objects. For example, FIGS. 5F-5G illustrate that a larger selection region 502 allows a user to more easily select farther objects, e.g., objects that may otherwise be relatively difficult to select due to their small perceived sizes. And FIG. 5G illustrates that a smaller selection region 502 allows a user to exercise greater control and/or precision when selecting closer objects that have larger perceived sizes.

In other examples, as discussed above with respect to suggestions unit 360, device 500 increases the size of suggestion region 502 if detected object(s) (e.g., 530, 540, and/or 550) are closer and device 500 decreases the size of suggestion region 502 if detected object(s) (e.g., 521) are farther away. Specifically, in an alternative example, the size of selection region 502 in FIGS. 5F and 5G is smaller than the size of selection region 502 in FIG. 5H, thereby allowing the user to more precisely select among farther objects (e.g., to select object 521 from among multiple trees in the background) for suggestions and to more easily select closer objects (e.g., to select all of objects 530, 540, and 550) for suggestions.

In FIGS. 6A-6C, selection region 602 is a 3D region within the 3D scene. Specifically, selection region 602 is the portion of the user’s field of view the 3D scene that can be viewed through virtual window 604 that is indicated by the dashed lines. Selection region 602 represents as far forward into the background of the 3D scene as the user can see through virtual window 604, so selection region 602 has substantially infinite depth. In some examples, device 500 does not display a representation of selection region 602 (e.g., virtual window 604) and virtual window 604 is for illustrative purpose only. In other examples, device 500 displays a representation of selection region 602, e.g., by displaying virtual window 604.

In FIGS. 6A-6B, selection region 602 has a default position in the 3D scene that depends on a pose of the user’s head, e.g., the pose of device 500, if device 500 is an HMD. For example, virtual window 604 is on a line that extends forward from the user’s head and/or eyes and that defines a user’s current forward-facing direction (e.g., relative to the user’s face and/or eyes) (e.g., a direction that changes when the user’s head changes pose). In FIGS. 6A-6B virtual window 604 is also a predetermined distance away from device 500 and/or the user.

In FIG. 6A, device 500 detects objects 606, 608, and 610 in the 3D scene. Device 500 determines that a property of object 606 (e.g., the location in the 3D scene of detected centroid 606-1 of object 606 and/or the space in the 3D scene occupied by object 606) is within selection region 602 and determines that none of the respective properties of objects 608 and 610 (e.g., the locations in the 3D scene of the detected respective centroids 608-1 and 610-1 of objects 608 and 610 and/or the respective spaces in the 3D scene occupied by objects 608 and 610) are within selection region 602. Device 500 thus displays suggestion 612 (to perform a web search using an image of object 606) that is determined based on object 606 and device 500 does not display any suggestions for objects 608 and 610. Device 500 further displays reticle 614 to indicate that suggestion 612 is for object 606.

In FIG. 6B, the view of the 3D scene changes due to the user turning their head. Because the position of selection region 602 depends on the pose of the user’s head, the position of selection region 602 within the 3D scene moves between FIGS. 6A-6B, as indicated by the new position of virtual window 604 in FIG. 6B.

In FIG. 6B, device 500 determines that the property of object 606 is no longer within selection region 602, that the property of object 610 remains outside of selection region 602, and that the property of object 608 is now within selection region 602. Device 500 thus ceases to display suggestion 612 for object 606 and displays suggestion 616 (to perform a web search using an image of object 608) that is determined based on object 608. Device 500 further displays reticle 614 around object 608 (and ceases to display reticle 614 around object 606) to indicate that suggestion 616 is for object 608.

Between FIGS. 6B-6C, device 500 receives a first user input that requests to move selection region 602 within the 3D scene, e.g., so the position of selection region 602 no longer depends on the user’s head pose. Between FIGS. 6B-6C, device 500 further receives a second user input that requests to adjust the actual size of selection region 602 (e.g., by adjusting the actual size of virtual window 604). In FIG. 6C, in response to receiving the first and second user inputs, device 500 moves selection region 602 as requested (e.g., farther away from the user towards the background of the 3D scene) and adjusts (e.g., reduces) the actual size of selection region 602 as requested. Thus, in FIG. 6C, the perceived size of selection region 602 (e.g., the perceived length and width of virtual window 604) appears smaller than in FIGS. 6A-6B not only because selection region 602 is moved farther away from the user, but also because the actual size of selection region 602 is reduced.

In FIG. 6C, device 500 determines that the property of object 608 is no longer within selection region 602 and that the property of object 610 (e.g., detected centroid 610-1 of object 610 in the 3D scene and/or the space in the 3D scene occupied by object 610) is now within selection region 602. Device 500 thus displays suggestion 618 (to perform a web search using an image of object 610) determined based on object 610 and ceases to display suggestion 616 for object 608. Device 500 further displays reticle 614 around object 610 (and ceases to display reticle 614 around object 608) to indicate that suggestion 618 is for object 610.

In FIGS. 7A-7B, selection region 702 is a 3D region within the 3D scene. Specifically, selection region 702 is the volume inside of shape 704 (e.g., a cube, a sphere, or another 3D object). Thus, unlike selection region 602, selection region 702 has a finite depth that corresponds to the depth of shape 704. In some examples, device 500 does not display a representation of selection region 702 (e.g., shape 704) and shape 704 is for illustrative purposes only. In other examples, device 500 displays a representation of selection region 702, e.g., by displaying shape 704.

In FIGS. 7A-7B, selection region 702 has a default position in the 3D scene that depends on a pose of the user’s head, e.g., the pose of device 500, if device 500 is an HMD. For example, shape 704 that is on a line that extends forward from the user’s head and/or eyes and that defines a user’s current forward-facing direction (e.g., relative to the user’s face and/or eyes). In FIGS. 7A-7B selection region 702 is also a predetermined distance away from device 500 and/or the user.

In FIG. 7A, device 500 detects objects 706 and 708. Device 500 determines that a property of object 706 (e.g., the location in the 3D scene of detected centroid 706-1 of object 706 and/or the space in the 3D scene occupied by object 706) is within selection region 702 and that a property of object 708 (e.g., the location in the 3D scene of detected centroid 708-1 of object 708 and/or the space in the 3D scene occupied by object 708) is not within selection region 702. Device 500 thus displays suggestion 710 (to perform a web search using an image of object 706) determined based on object 706 and does not display any suggestions for object 708. Device 500 further displays reticle 712 around object 706 to indicate that suggestion 710 is for object 706.

In FIG. 7B, the view of the 3D scene changes due to the user turning their head. Because the position of selection region 702 depends on the pose of the user’s head, the position of selection region 702 within the 3D scene moves between FIGS. 7A-7B, as indicated by the new position of selection region 702 and/or shape 704 in FIG. 7B.

In FIG. 7B, device 500 determines that the property of object 706 is no longer within selection region 702 and that the property of object 708 is now within selection region 702. Device 500 thus displays suggestion 714 (to perform a web search using an image of object 708) that is determined based on object 708 and ceases to display suggestion 710. Device 500 further displays reticle 712 around object 708 (and ceases to display reticle 712 around object 706) to indicate that suggestion 714 is for object 708.

Any of the techniques described with respect to any one of FIGS. 5A-5H, 6A-6C, and 7A-7B can be combined with any of the techniques described with respect to any other one of FIGS. 5A-5H, 6A-6C, and 7A-7B. For example, device 500 adjusts the size of selection region 602 or selection region 702 (e.g., by adjusting the actual size of virtual window 604 or by adjusting the actual size of shape 704, respectively) based on a size of an object and/or based on a distance between device 500 and an object, as discussed with respect to FIGS. 5A-5H. As another example, device 500 adjusts the position and/or size of selection region 502 or selection region 702 in response to a user input, as discussed with respect to FIGS. 6A-6C.

Additional descriptions regarding FIGS. 5A-5H, 6A-6C, and 7A-7B are provided below in reference to method 800 described below with respect to FIG. 8.

FIG. 8 is a flow diagram of a method 800 for providing suggestions, according to some examples. In some examples, method 800 is performed at a computer system (e.g., computer system 101 in FIG. 1 and/or device 500) that is in communication with one or more sensor devices (e.g., image sensors, light sensors, depth sensors, tactile sensors, orientation sensors, proximity sensors, temperature sensors, location sensors, motion sensors, velocity sensors, audio sensors, and/or biometric sensors). In some examples, method 800 is governed by instructions that are stored in a non-transitory (or transitory) computer-readable storage medium and that are executed by one or more processors of a computer system, such as the one or more processing unit(s) 302 of computer system 101 (e.g., controller 110 in FIG. 1). In some examples, the operations of method 800 are distributed across multiple computer systems, e.g., a computer system and a separate server system. Some operations in method 800 are, optionally, combined, the orders of some operations are, optionally, changed, and some operations are, optionally, omitted.

Method 800 includes detecting (802), via the one or more sensor devices, a first object (e.g., 504, 506, 518, 519, 521, 530, 540, 550, 606, 608, 610, 706, and/or 708) within a three-dimensional (3D) scene.

Method 800 includes in response to (804) detecting, via the one or more sensor devices, the first object within the 3D scene: in accordance with a determination (806) (e.g., by suggestions unit 360) that a set of one or more criteria is satisfied, wherein the set of one or more criteria includes a first criterion that is satisfied when a property of the first object is within a predefined region (e.g., 502, 602, or 702) associated with the 3D scene, providing (808) a suggestion (e.g., 508-1, 508-2, 508-3, 508-4, 508-5, 508-6, 520, 522, 542, 612, 616, 618, 710, and/or 714) that is determined based on the first object; and in accordance with a determination (806) (e.g., by suggestions unit 360) that the set of one or more criteria is not satisfied, forgoing (810) providing the suggestion that is determined based on the first object.

In some examples, the suggestion that is determined based on the first object is provided without receiving a (e.g., any) user input corresponding to a selection of the first object (e.g., without receiving user input other than input that moves the object into the field of view of the one or more image sensors and/or that points the one or more image sensors at the first object).

In some examples, the first object (e.g., 504, 506, 518, and/or 519) includes text.

In some examples, detecting the first object within the 3D scene includes classifying (e.g., using suggestions unit 360) the text as a block of text.

In some examples, the property of the first object (e.g., 504, 506, 518, 519, 521, 530, 540, 550, 606, 608, 610, 706, and/or 708) includes a centroid corresponding to the first object (e.g., an effective centroid) (e.g., 504-1, 506-1, 504-2, 506-2, 518-1, 519-1, 518-2, 519-2, 521-1, 521-2, 530-1, 540-1, 550-1, 606-1, 608-1, 610-1, 706-1, and/or 708-1).

In some examples, the property of the first object (e.g., 504, 506, 518, 519, 521, 530, 540, 550, 606, 608, 610, 706, and/or 708) includes a region corresponding to the first object (e.g., an effective region).

In some examples, the 3D scene includes a second object (e.g., 514) different from the first object, and method 800 further includes: receiving a user input (e.g., 512) corresponding to a selection of the second object; and in response to receiving the user input corresponding to the selection of the second object, providing a suggestion (e.g., 516) that is determined based on the second object.

In some examples, a property of the second object (e.g., a centroid corresponding to the second object (e.g., 514-1) and/or a region corresponding to the second object) is not within the predefined region associated with the 3D scene (e.g., 502) when the user input corresponding to the selection of the second object is received.

In some examples, the computer system is in communication with a display generation component, and method 800 further includes: in response to receiving the user input corresponding to the selection of the second object, displaying, via the display generation component, a first reticle (e.g., 510 in FIG. 5C) around the second object.

In some examples, the computer system is in communication with a display generation component, and method 800 further includes: in response to receiving the user input corresponding to the selection of the second object, displaying, via the display generation component, an indication that the second object is selected.

In some examples, the 3D scene (e.g., the 3D scene of FIG. 5A) includes a third object (e.g., 506) different from the first object (e.g., 504), and method 800 further includes: detecting, via the one or more sensor devices, the third object; and in response to detecting, via the one or more sensor devices, the third object: in accordance with a determination that a property of the third object (e.g., a centroid corresponding to the third object (e.g., 506-1) and/or a region corresponding to the third object) is within the predefined region (e.g., 502) associated with the 3D scene, providing a suggestion (e.g., 508-3 and/or 508-4) that is determined based on the third object, wherein the suggestion that is determined based on the third object is concurrently provided with the suggestion that is determined based on the first object (e.g., 508-1 and/or 508-2); and in accordance with a determination that the property of the third object is not within the predefined region associated with the 3D scene, forgoing providing the suggestion that is determined based on the third object. In some examples, the third object and the first object are each detected when the one or more image sensors have the same field of view.

In some examples, method 800 includes adjusting, based on an adjustment criterion, a dimension of the predefined region associated with the 3D scene (e.g., as illustrated by the transition between FIGS. 5C and 5D and/or the transition between FIG. 5G and 5H).

In some examples, the first object (e.g., 504, 506, 518, and/or 519) includes second text, and the adjustment criterion includes a font size of the second text.

In some examples, the adjustment criterion includes a distance between the computer system and the first object (e.g., 521, 530, 540, and/or 550).

In some examples, a (e.g., any) representation of the predefined region (e.g., 502, 602, and/or 702) associated with the 3D scene is not displayed.

In some examples, the computer system is in communication with a display generation component, and method 800 further includes: concurrently providing, with the suggestion that is determined based on the first object (e.g., 508-1 and/or 508-2), a suggestion that is determined based on a fourth object (e.g., 506) in the 3D scene, wherein the fourth object is different from the first object (e.g., 504), and wherein a property of the fourth object (e.g., a centroid corresponding to the fourth object (e.g., 506-1) and/or a region corresponding to the fourth object) is within the predefined region associated with the 3D scene (e.g., 502); and while concurrently providing the suggestion that is determined based on the first object and the suggestion that is determined based on the fourth object, displaying, via the display generation component, a single reticle (e.g., 510 in FIG. 5A) corresponding to the first object and the fourth object.

In some examples, a dimension of the single reticle is based on a dimension of the first object and a dimension of the fourth object.

In some examples, the first object (e.g., 504) is detected and the suggestion that is determined based on the first object is provided when the one or more sensor devices have a first field of view (e.g., the field of view of FIG. 5A) and method 800 further includes: after providing (e.g., after initially providing) the suggestion that is determined based on the first object and while the one or more sensor devices have a second field of view (e.g., the field of view of FIG. 5B) different from the first field of view: detecting (e.g., continuing to detect), via the one or more sensor devices, the first object within the 3D scene (e.g., 504); and in response to detecting, via the one or more sensor devices, the first object within the 3D scene: in accordance with a determination that the set of one or more criteria is satisfied, continuing to provide the suggestion that is determined based on the first object; and in accordance with a determination that the set of one or more criteria is not satisfied, ceasing to provide the suggestion (e.g., 508-1, 508-2, and/or 508-5) that is determined based on the first object (e.g., as illustrated by the transition between FIGS. 5A-5B).

In some examples, method 800 further includes: in response to detecting, via the one or more sensor devices, the first object within the 3D scene: in accordance with a determination that the set of one or more criteria is satisfied, providing a second suggestion (e.g., 508-1 and/or 508-2) that is determined based on the first object, wherein the suggestion (e.g., 508-1 and/or 508-2) that is determined based on the first object (e.g., 504) corresponds to an action to be performed by a first application, and wherein the second suggestion that is determined based on the first object corresponds to an action to be performed by a second application different from the first application.

In some examples, the first object (e.g., 504, 506, 518, and/or 519) includes respective text, and wherein the set of one or more criteria includes a second criterion that is satisfied based on a size of the respective text.

In some examples, the set of one or more criteria includes a third criterion that is satisfied when a confidence score of the suggestion that is determined based on the first object exceeds a threshold confidence score.

In some examples, the computer system is in communication with a display generation component, and method 800 further includes: in response to detecting, via the one or more sensor devices, the first object within the 3D scene: in accordance with a determination that the set of one or more criteria is not satisfied, forgoing displaying, via the display generation component, a (e.g., any) reticle (e.g., 510, 614, and/or 712) corresponding to the first object. In some examples, method 800 includes, in accordance with a determination that no suggestions are provided, forgoing displaying, via the display generation component, a reticle. In some examples, method 800 includes, in response to detecting one or more objects within the 3D scene, displaying, via the display generation component, a reticle corresponding to the one or more objects, regardless of whether suggestions are provided for the one or more objects.

In some examples, method 800 includes: receiving a user input corresponding to a selection of the suggestion that is determined based on the first object; and in response to receiving the user input corresponding to the selection of the suggestion that is determined based on the first object, initiating a task (e.g., a phone call task, an email task, a text-to-speech task, and/or a web search task) that corresponds to the suggestion.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to facilitate user interactions with a three-dimensional scene. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide suggestions. Further, other uses for personal information data that benefit the user are also contemplated by the present disclosure. For instance, health and fitness data may be used to provide insights into a user’s general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing suggestions for the user, the present technology can be configured to allow users to select to “opt in” or “opt out” of participation in the collection of personal information data during registration for services or anytime thereafter. In another example, users can select not to provide personal information data based on which suggestions are determined. In yet another example, users can select to limit the length of time for which such data is maintained. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, suggestions can be determined based on non-personal information data or a bare minimum amount of personal information, such as the content being requested by the device associated with a user, other non-personal information available to the device, or publicly available information.

What is claimed is:

1. A computer system configured to communicate with one or more sensor devices, the computer system comprising:
one or more processors; and
memory storing one or more programs configured to be executed by the one or more processors, the one or more programs including instructions for:
detecting, via the one or more sensor devices, a first object within a three-dimensional (3D) scene; and
in response to detecting, via the one or more sensor devices, the first object within the 3D scene:
in accordance with a determination that a set of one or more criteria is satisfied, wherein the set of one or more criteria includes a first criterion that is satisfied when a property of the first object is within a predefined region associated with the 3D scene, providing a suggestion that is determined based on the first object; and
in accordance with a determination that the set of one or more criteria is not satisfied, forgoing providing the suggestion that is determined based on the first object.

2. The computer system of claim 1, wherein the suggestion that is determined based on the first object is provided without receiving a user input corresponding to a selection of the first object.

3. The computer system of claim 1, wherein the first object includes text.

4. The computer system of claim 1, wherein detecting the first object within the 3D scene includes classifying the text as a block of text.

5. The computer system of claim 1, wherein the property of the first object includes a centroid corresponding to the first object.

6. The computer system of claim 1, wherein the property of the first object includes a region corresponding to the first object.

7. The computer system of claim 1, wherein the 3D scene includes a second object different from the first object, and wherein the one or more programs further include instructions for:
receiving a user input corresponding to a selection of the second object; and
in response to receiving the user input corresponding to the selection of the second object, providing a suggestion that is determined based on the second object.

8. The computer system of claim 7, wherein a property of the second object is not within the predefined region associated with the 3D scene when the user input corresponding to the selection of the second object is received.

9. The computer system of claim 7, wherein the computer system is in communication with a display generation component, and wherein the one or more programs further include instructions for:
in response to receiving the user input corresponding to the selection of the second object, displaying, via the display generation component, a first reticle around the second object.

10. The computer system of claim 7, wherein the computer system is in communication with a display generation component, and wherein the one or more programs further include instructions for:
in response to receiving the user input corresponding to the selection of the second object, displaying, via the display generation component, an indication that the second object is selected.

11. The computer system of claim 1, wherein the 3D scene includes a third object different from the first object, and wherein the one or more programs further include instructions for:
detecting, via the one or more sensor devices, the third object; and
in response to detecting, via the one or more sensor devices, the third object:
in accordance with a determination that a property of the third object is within the predefined region associated with the 3D scene, providing a suggestion that is determined based on the third object, wherein the suggestion that is determined based on the third object is concurrently provided with the suggestion that is determined based on the first object; and
in accordance with a determination that the property of the third object is not within the predefined region associated with the 3D scene, forgoing providing the suggestion that is determined based on the third object.

12. The computer system of claim 1, wherein the one or more programs further include instructions for:
adjusting, based on an adjustment criterion, a dimension of the predefined region associated with the 3D scene.

13. The computer system of claim 12, wherein the first object includes second text, and wherein the adjustment criterion includes a font size of the second text.

14. The computer system of claim 12, wherein the adjustment criterion includes a distance between the computer system and the first object.

15. The computer system of claim 1, wherein a representation of the predefined region associated with the 3D scene is not displayed.

16. The computer system of claim 1, wherein the computer system is in communication with a display generation component, and wherein the one or more programs further include instructions for:
concurrently providing, with the suggestion that is determined based on the first object, a suggestion that is determined based on a fourth object in the 3D scene, wherein the fourth object is different from the first object, and wherein a property of the fourth object is within the predefined region associated with the 3D scene; and
while concurrently providing the suggestion that is determined based on the first object and the suggestion that is determined based on the fourth object, displaying, via the display generation component, a single reticle corresponding to the first object and the fourth object.

17. The computer system of claim 16, wherein a dimension of the single reticle is based on a dimension of the first object and a dimension of the fourth object.

18. The computer system of claim 1, wherein the first object is detected and the suggestion that is determined based on the first object is provided when the one or more sensor devices have a first field of view, and wherein the one or more programs further include instructions for:
after providing the suggestion that is determined based on the first object and while the one or more sensor devices have a second field of view different from the first field of view:
detecting, via the one or more sensor devices, the first object within the 3D scene; and
in response to detecting, via the one or more sensor devices, the first object within the 3D scene:
in accordance with a determination that the set of one or more criteria is satisfied, continuing to provide the suggestion that is determined based on the first object; and
in accordance with a determination that the set of one or more criteria is not satisfied, ceasing to provide the suggestion that is determined based on the first object.

19. The computer system of claim 1, wherein the one or more programs further include instructions for:
in response to detecting, via the one or more sensor devices, the first object within the 3D scene:
in accordance with a determination that the set of one or more criteria is satisfied, providing a second suggestion that is determined based on the first object, wherein the suggestion that is determined based on the first object corresponds to an action to be performed by a first application, and wherein the second suggestion that is determined based on the first object corresponds to an action to be performed by a second application different from the first application.

20. The computer system of claim 1, wherein the first object includes respective text, and wherein the set of one or more criteria includes a second criterion that is satisfied based on a size of the respective text.

21. The computer system of claim 1, wherein the set of one or more criteria includes a third criterion that is satisfied when a confidence score of the suggestion that is determined based on the first object exceeds a threshold confidence score.

22. The computer system of claim 1, wherein the computer system is in communication with a display generation component, and wherein the one or more programs further include instructions for:
in response to detecting, via the one or more sensor devices, the first object within the 3D scene:
in accordance with a determination that the set of one or more criteria is not satisfied, forgoing displaying, via the display generation component, a reticle corresponding to the first object.

23. A non-transitory computer-readable storage medium storing one or more programs configured to be executed by one or more processors of a computer system that is in communication with one or more sensor devices, the one or more programs including instructions for:
detecting, via the one or more sensor devices, a first object within a three-dimensional (3D) scene; and
in response to detecting, via the one or more sensor devices, the first object within the 3D scene:
in accordance with a determination that a set of one or more criteria is satisfied, wherein the set of one or more criteria includes a first criterion that is satisfied when a property of the first object is within a predefined region associated with the 3D scene, providing a suggestion that is determined based on the first object; and
in accordance with a determination that the set of one or more criteria is not satisfied, forgoing providing the suggestion that is determined based on the first object.

24. A method, comprising:
at a computer system that is in communication with one or more sensor devices:
detecting, via the one or more sensor devices, a first object within a three-dimensional (3D) scene; and
in response to detecting, via the one or more sensor devices, the first object within the 3D scene:
in accordance with a determination that a set of one or more criteria is satisfied, wherein the set of one or more criteria includes a first criterion that is satisfied when a property of the first object is within a predefined region associated with the 3D scene, providing a suggestion that is determined based on the first object; and
in accordance with a determination that the set of one or more criteria is not satisfied, forgoing providing the suggestion that is determined based on the first object.
